(19) United States
(12) Patent Application Publication
(10) Pub. No.: US 2026/0181647 A1
(43) Pub. Date: Jun. 25, 2026

(54) TERMINAL APPARATUS

(71) Applicant: SHARP KABUSHIKI KAISHA, Sakai City, Osaka (JP)

(72) Inventors: Takahisa FUKUI, Sakai City, Osaka (JP); KAZUNARI YOKOMAKURA, Sakai City, Osaka (JP)

(21) Appl. No.: 19/123,147

(22) PCT Filed: Oct. 6, 2023
(86) PCT No.: PCT/JP2023/036525

§ 371 Date: Apr. 22, 2025

(30) Foreign Application Priority Data
Oct. 28, 2022 (JP) 2022-173330

(51) Int. Cl. H04W 72/23; H04W 74/0833

(52) U.S. Cl. CPC H04W 72/23; H04W 74/0833

(57) ABSTRACT

A receiver that receives a PDCCH to which DCI is mapped, and a transmitter that transmits a random access preamble in a random access procedure initiated by the PDCCH are included, wherein in a case that the DCI includes a DCI field and in a case that the DCI field indicates a first value, the random access procedure is initiated based on a first higher layer parameter, in a case that the DCI includes the DCI field and in a case that the DCI field indicates a second value, the random access procedure is initiated based on a second higher layer parameter, in a case that the DCI does not include the DCI field, the random access procedure is initiated based on a third higher layer parameter, all of the first higher layer parameter, the second higher layer parameter, and the third higher layer parameter include an RACH configuration, and the first higher layer parameter corresponds to one additional PCI index.

### TECHNICAL FIELD

The present invention relates to a terminal apparatus.

This application claims priority to JP 2022-173330 filed on Oct. 28, 2022, the contents of which are incorporated herein by reference.

### BACKGROUND ART

In the 3^{rd} Generation Partnership Project (3GPP), a radio access method and a radio network for cellular mobile communications (hereinafter also referred to as “Long Term Evolution (LTE)” or “Evolved Universal Terrestrial Radio Access (EUTRA)”) have been studied. In LTE, a base station apparatus is also referred to as an evolved NodeB (eNodeB) and a terminal apparatus is also referred to as a User Equipment (UE). LTE is a cellular communication system in which multiple areas covered by base station apparatuses are arranged in a form of cells. A single base station apparatus may manage multiple serving cells.

The 3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is to satisfy requirements for three scenarios including enhanced Mobile BroadBand (eMBB), massive Machine Type Communication (mMTC), and Ultra Reliable and Low Latency Communication (URLLC) in a single technology framework.

In the 3GPP, extension of services supported by NR has been studied (NPL 2).

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7 to 10 Mar. 2016.
NPL 2: “Release 17 package for RAN”, RP-193216, RAN chairman, RAN1 chairman, RAN2 chairman, RAN3 chairman, 3GPP TSG RAN Meeting #86, Sitges, Spain, 9 to 12 Dec. 2019
NPL 3: “Release 18 package summary”, RP-213469, RAN chairman, RAN1 chairman, RAN2 chairman, RAN3 chairman, 3GPP TSG RAN Meeting #94-e, 6 to 17 Dec. 2021

### SUMMARY OF INVENTION

### Technical Problem

An aspect of the present invention provides a terminal apparatus that efficiently performs communication, a communication method used in the terminal apparatus, a base station apparatus that efficiently performs communication, and a communication method used in the base station apparatus.

### Solution to Problem

(1) A first aspect of the present invention is a terminal apparatus including a receiver configured to receive a PDCCH to which DCI is mapped, and a transmitter configured to transmit a random access preamble in a random access procedure initiated by the PDCCH, wherein in a case that the DCI includes a DCI field and in a case that the DCI field indicates a first value, the random access procedure is initiated based on a first higher layer parameter, in a case that the DCI includes the DCI field and in a case that the DCI field indicates a second value, the random access procedure is initiated based on a second higher layer parameter, in a case that the DCI does not include the DCI field, the random access procedure is initiated based on a third higher layer parameter, all of the first higher layer parameter, the second higher layer parameter, and the third higher layer parameter include an RACH configuration, and the first higher layer parameter corresponds to one additional PCI index.

(2) A second aspect of the present invention is a base station apparatus including a transmitter configured to transmit a PDCCH to which DCI is mapped, and a receiver configured to receive a random access preamble in a random access procedure initiated by the PDCCH, wherein in a case that the DCI includes a DCI field and in a case that the DCI field indicates a first value, the random access procedure is initiated based on a first higher layer parameter, in a case that the DCI includes the DCI field and in a case that the DCI field indicates a second value, the random access procedure is initiated based on a second higher layer parameter, in a case that the DCI does not include the DCI field, the random access procedure is initiated based on a third higher layer parameter, all of the first higher layer parameter, the second higher layer parameter, and the third higher layer parameter include an RACH configuration, and the first higher layer parameter corresponds to one additional PCI index.

(3) A third aspect of the present invention is a terminal apparatus including a receiver configured to receive a PDCCH to which DCI is mapped, and a transmitter configured to transmit a random access preamble in a random access procedure initiated by the PDCCH, wherein in a case that a CORESET pool index corresponding to the PDCCH is a first value, the random access procedure is initiated based on a first higher layer parameter, in a case that a CORESET pool index corresponding to the PDCCH is a second value, the random access procedure is initiated based on a second higher layer parameter, in a case that the first higher layer parameter is not configured, the random access procedure is initiated based on a third higher layer parameter, and all of the first higher layer parameter, the second higher layer parameter, and the third higher layer parameter include an RACH configuration.

(4) A fourth aspect of the present invention is a base station apparatus including a transmitter configured to transmit a PDCCH to which DCI is mapped, and a receiver configured to receive a random access preamble in a random access procedure initiated by the PDCCH, wherein in a case that a CORESET pool index corresponding to the PDCCH is a first value, the random access procedure is initiated based on a first higher layer parameter, in a case that a CORESET pool index corresponding to the PDCCH is a second value, the random access procedure is initiated based on a second higher layer parameter, in a case that the first higher layer parameter is not configured, the random access procedure is initiated based on a third higher layer parameter, and all of the first higher layer parameter, the second higher layer parameter, and the third higher layer parameter include an RACH configuration.

### Advantageous Effects of Invention

According to an aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between a subcarrier spacing configuration u, the number of OFDM symbols per slot N^{slot}_{symb}, and a cyclic Prefix (CP) configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid 3001 according to an aspect of the present embodiment.

FIG. 5 is a schematic block diagram illustrating a configuration example of a base station apparatus 3 according to an aspect of the present embodiment.

FIG. 6 is a schematic block diagram illustrating a configuration example of a terminal apparatus 1 according to an aspect of the present embodiment.

FIG. 7 is a diagram illustrating a configuration example of an SS/PBCH block according to an aspect of the present embodiment.

FIG. 8 is a diagram illustrating an example of monitoring occasions for search space sets according to an aspect of the present embodiment.

FIG. 9 is a diagram illustrating an example of a secondary TA acquisition according to an aspect of the present embodiment.

FIG. 10 is a diagram illustrating examples of means 1a, 1b, and 1c according to an aspect of the present embodiment.

FIG. 11 is a diagram illustrating examples of means 2a and 2b according to an aspect of the present embodiment.

### DESCRIPTION OF EMBODIMENTS

An embodiment of the present invention will be described below.

floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=e\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “·” represents multiplication.

In the radio communication system according to an aspect of the present embodiment, at least Orthogonal Frequency Division Multiplex (OFDM) is used. The OFDM symbol is a time domain unit of the OFDM. The OFDM symbol includes at least one or multiple subcarriers. The OFDM symbol is converted into a time-continuous signal in baseband signal generation. In downlink, at least Cyclic Prefix-Orthogonal Frequency Division Multiplex (CP-OFDM) is used. In uplink, either CP-OFDM or Discrete Fourier Transform-spread-Orthogonal Frequency Division Multiplex (DFT-s-OFDM) is used. DFT-s-OFDM may be given by applying Transform precoding to the CP-OFDM.

The OFDM symbol may be a term including a CP added to the OFDM symbol. That is, a certain OFDM symbol may include the certain OFDM symbol and the CP added to the certain OFDM symbol.

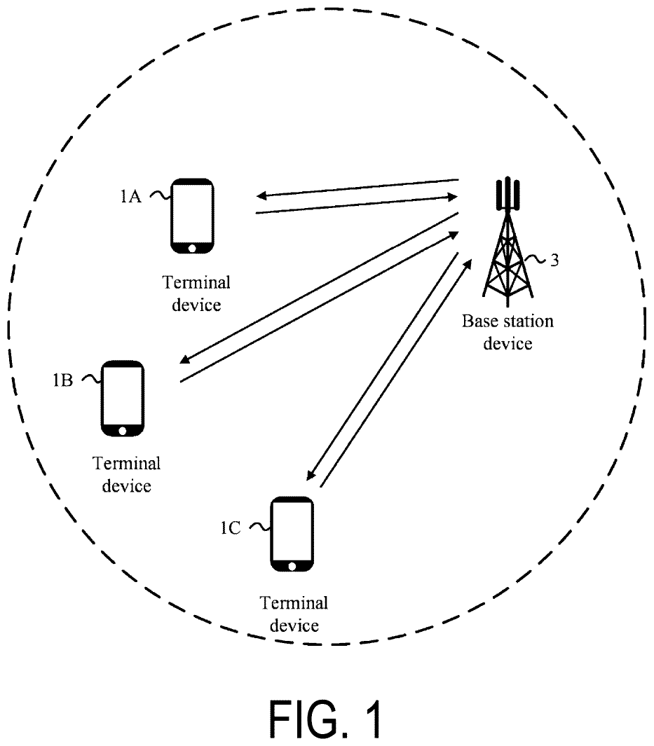

FIG. 1 is a conceptual diagram of a radio communication system according to an aspect of the present embodiment. In FIG. 1, the radio communication system includes at least terminal apparatuses 1A to 1C and a base station apparatus 3 (Base station #3 (BS #3)). Hereinafter, the terminal apparatuses 1A to 1C are also referred to as a terminal apparatus 1 (User Equipment #1 (UE #1)).

The base station apparatus 3 may include one or multiple transmission apparatuses (or transmission points, transmission and/or reception apparatuses, transmission and/or reception points). In a case that the base station apparatus 3 includes multiple transmission apparatuses, the multiple transmission apparatuses may be arranged at different positions. For example, the base station apparatus 3 may include a transmission apparatus 3a and a transmission apparatus 3b. For example, the base station apparatus 3 may include a transmission and/or reception point 3a and a transmission and/or reception point 3b. For example, the base station apparatus 3 may include a transmission and/or reception apparatus 3a and a transmission and/or reception apparatus 3b.

The base station apparatus 3 may provide one or multiple serving cells. Each serving cell may be defined as a set of resources used for radio communication. In addition, the serving cell is also referred to as a cell.

The serving cell may include one or both of one downlink component carrier (downlink carrier) and one uplink component carrier (uplink carrier). The serving cell may include either or both of two or more downlink component carriers, and/or two or more uplink component carriers. The downlink component carrier and the uplink component carrier are also collectively referred to as a component carrier (carrier).

For example, for each component carrier, one resource grid may be given. In addition, for each set of one component carrier and a certain subcarrier spacing configuration u, one resource grid may be given. Here, the subcarrier spacing configuration u is also referred to as numerology. For example, for a set of a certain antenna port p, a certain subcarrier spacing configuration u, and a certain transmission direction x, one resource grid may be given.

The resource grid includes N^{size, μ}_{grid, x}N^{RB}_{sc} subcarriers. Here, the resource grid starts from a common resource block N^{start, μ}_{grid, x}. In addition, the common resource block N^{start, μ}_{grid, x} is also referred to as a reference point of the resource grid.

The resource grid includes N^{subframe, μ}_{symb} OFDM symbols.

The subscript x added to the parameter associated with the resource grid indicates the transmission direction. For example, the subscript x may be used to indicate either of downlink or uplink.

N^{size, μ}_{grid, x} is an offset configuration indicated by a parameter provided by the RRC layer (e.g., parameter CarrierBandwidth). N^{start, μ}_{grid, x} is a band configuration indicated by a parameter provided by the RRC layer (e.g., parameter, OffsetToCarrier). The offset configuration and the band configuration are configurations used for configuring an SCS-specific carrier.

The SubCarrier Spacing (SCS) Δf for a certain subcarrier spacing configuration u may be Δf satisfying Δf=2^{μ}·15 kHz. Here, the subcarrier spacing configuration u may indicate one of 0, 1, 2, 3, or 4.

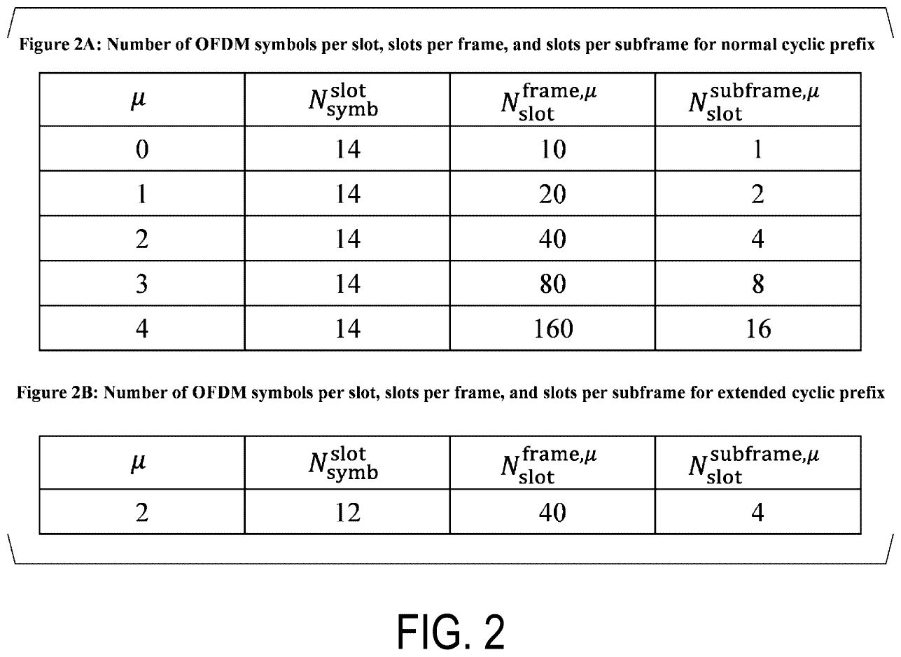

FIG. 2 is an example illustrating a relationship between the subcarrier spacing configuration u, the number of OFDM symbols per slot N^{slot}_{symb}, and a cyclic Prefix (CP) configuration according to an aspect of the present embodiment. In FIG. 2A, for example, in a case that the subcarrier spacing configuration u is 2 and the CP configuration is a normal cyclic prefix (normal CP), N^{slot}_{symb}=14, N^{frame, μ}ₛₗₒₜ=40, and N^{subframe, μ}ₛₗₒₜ=4. In addition, in FIG. 2B, for example, in a case that the subcarrier spacing configuration u is 2 and the CP configuration is an extended cyclic prefix (extended CP), N^{slot}_{symb}=12, N^{frame, μ}ₛₗₒₜ=40, and N^{subframe, μ}ₛₗₒₜ=4.

The time unit T_{c} may be used to represent the length of the time domain. The time unit T_{c} is T_{c}=1/(Δfₘₐₓ·N_{f}). Δfₘₐₓ=480 kHz. N_{f}=4096. A constant κ is κ=Δfₘₐₓ·N_{f}/(Δf_{ref}N_{f, ref})=64. Δf_{ref} is 15 kHz. N_{f, ref} is 2048.

Transmission of a signal in the downlink and/or transmission of a signal in the uplink may be organized into a radio frame (system frame, frame) having the length T_{f}. T_{f}=(ΔfₘₐₓN_{f}/100)·Tₛ=10 ms. The radio frame includes 10 subframes. The length T_{sf} of the subframe is (ΔfₘₐₓN_{f}/1000)·Tₛ=1 ms. The number of OFDM symbols per subframe is N^{subframe, μ}_{symb}=N^{slot}_{symb}N^{subframe, μ}ₛₗₒₜ.

On one carrier, there are a first set of one or multiple frames in uplink and a second set of one or multiple frames in downlink. An uplink frame for transmission from the terminal apparatus 1 is started T_{TA} before the start of a downlink frame. T_{TA} may be (N_{TA}·N_{TA, offset}) T_{c}.

The OFDM symbol is a time domain unit of one communication scheme. For example, the OFDM symbol may be a time domain unit of CP-OFDM. In addition, the OFDM symbol may be a time domain unit of DFT-s-OFDM.

The slot may include multiple OFDM symbols. For example, N^{slot}_{symb} continuous OFDM symbols may constitute one slot. For example, in a normal CP configuration, N^{slot}_{symb} may be 14. In addition, in an extended CP configuration, N^{slot}_{symb} may be 12.

For a certain subcarrier spacing configuration μ, the number and index of a slot included in the subframe may be given. For example, slot indices n^{μ}ₛ may be given in ascending order in the subframe with integer values within a range of 0 to N^{subframe, μ}ₛₗₒₜ−1. For the subcarrier spacing configuration μ, the number and index of a slot included in the radio frame may be given. In addition, slot indices n^{μ}_{s, f} may be given in ascending order in the radio frame with integer values within a range of 0 to N^{frame, μ}ₛₗₒₜ−1.

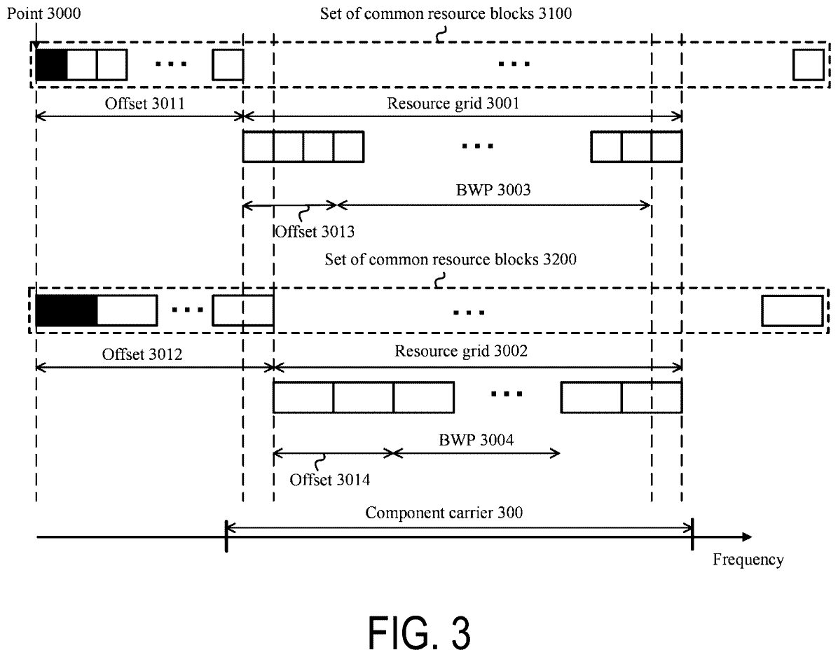

FIG. 3 is a diagram illustrating an example of a configuration method of a resource grid according to an aspect of the present embodiment. The horizontal axis of FIG. 3 represents a frequency domain. FIG. 3 illustrates a configuration example of a resource grid of a subcarrier spacing μ₁ in a component carrier 300, and a configuration example of a resource grid of a subcarrier spacing μ₂ in the certain component carrier. As described above, for a certain component carrier, one or multiple subcarrier spacings may be configured. In FIG. 3, it is assumed that μ₁=μ₂−1, but various aspects of the present embodiment are not limited to the condition of μ₁=μ₂−1.

The component carrier 300 is a band having a prescribed width in the frequency domain.

A point 3000 is an identifier for identifying a certain subcarrier. The point 3000 is also referred to as a point A. A common resource block (CRB) set 3100 is a set of common resource blocks for the configuration of the subcarrier spacing μ₁.

In the common resource block set 3100, a common resource block (solid black block in the common resource block set 3100 in FIG. 3) including the point 3000 is also referred to as a reference point of the common resource block set 3100. The reference point of the common resource block set 3100 may be a common resource block having an index 0 in the common resource block set 3100.

An offset 3011 is an offset from the reference point of the common resource block set 3100 to a reference point of a resource grid 3001. The offset 3011 is represented by the number of common resource blocks for the configuration of the subcarrier spacing μ₁. The resource grid 3001 includes N^{size, μ}_{grid1, x} common resource blocks starting from the reference point of the resource grid 3001.

An offset 3013 is an offset from the reference point of the resource grid 3001 to a reference point (N^{start, μ}_{BWP, i1}) of a bandwidth part (BWP) 3003 having an index i1.

A common resource block set 3200 is a set of common resource blocks for the configuration of the subcarrier spacing μ₂.

In the common resource block set 3200, a common resource block (solid black block in the common resource block set 3200 in FIG. 3) including the point 3000 is also referred to as a reference point of the common resource block set 3200. The reference point of the common resource block set 3200 may be a common resource block having an index 0 in the common resource block set 3200.

An offset 3012 is an offset from the reference point of the common resource block set 3200 to a reference point of a resource grid 3002. The offset 3012 is represented by the number of common resource blocks for the subcarrier spacing μ₂. The resource grid 3002 includes N^{size, μ}_{grid2, x} common resource blocks starting from the reference point of the resource grid 3002.

An offset 3014 is an offset from the reference point of the resource grid 3002 to a reference point (N^{start, μ}_{BWP, i2}) of a BWP 3004 having an index i2.

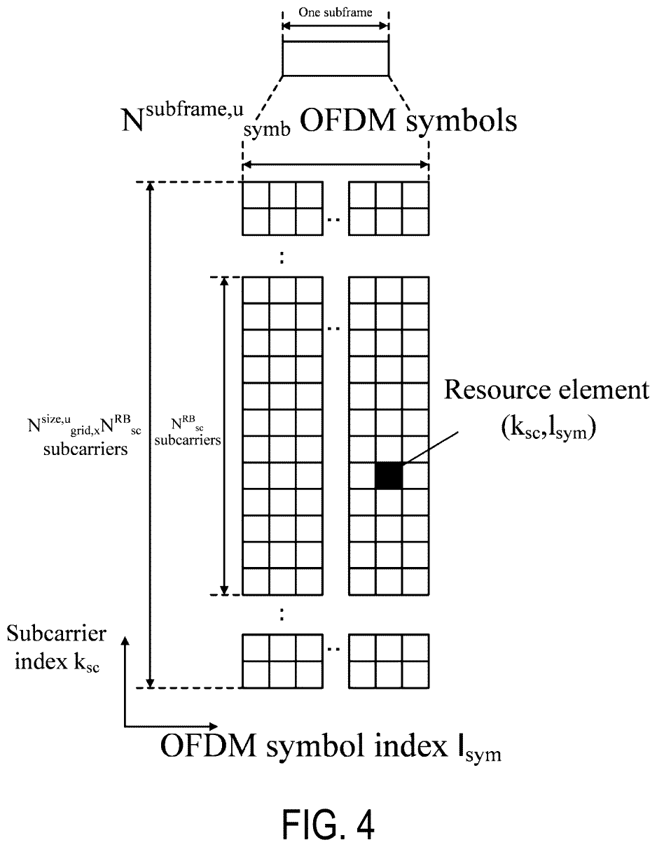

FIG. 4 is a diagram illustrating a configuration example of the resource grid 3001 according to an aspect of the present embodiment. In the resource grid of FIG. 4, the horizontal axis corresponds to an OFDM symbol index l_{sym}, and the vertical axis corresponds to a subcarrier index k_{sc}. The resource grid 3001 includes N^{size, μ}_{grid1, x}N^{RB}_{sc} subcarriers, and N^{subframe, μ}_{symb} OFDM symbols. In the resource grid, a resource identified by the subcarrier index k_{sc} and the OFDM symbol index l_{sym} is also referred to as a resource element (RE).

The resource block (RB) includes N^{RB}_{sc} consecutive subcarriers. The resource block is a general term for a common resource block, a physical resource block (PRB), and a virtual resource block (VRB). Here, N^{RB}_{sc} is 12.

A resource block unit is a set of resources corresponding to one OFDM symbol in one resource block. That is, one resource block unit includes 12 resource elements corresponding to one OFDM symbol in one resource block.

The common resource blocks for the configuration of a certain subcarrier spacing u are assigned indices (indexing) in ascending order from 0 in the frequency domain in a certain common resource block set. The common resource block having the index 0 for the configuration of a certain subcarrier spacing u includes (collides with or matches) the point 3000. An index n^{μ}_{CRB} of the common resource block for the configuration of the certain subcarrier spacing u satisfies the relationship of n^{μ}_{CRB}=ceil (k_{sc}/N^{RB}_{sc}). Here, a subcarrier with K_{sc}=0 is a subcarrier having the same center frequency as the center frequency of a subcarrier corresponding to the point 3000.

Physical resource blocks for the configuration of the certain subcarrier spacing μ are assigned indices in ascending order from 0 in the frequency domain in a certain BWP. An index n^{μ}_{PRB} of the physical resource block for the configuration of the certain subcarrier spacing cu satisfies the relationship of n^{μ}_{CRB}=n^{μ}_{PRB}+N^{start, μ}_{BWP, i}. Here, N^{start, μ}_{BWP, i} indicates a reference point of the BWP having an index i.

The BWP is defined as a subset of common resource blocks included in the resource grid. The BWP includes N^{size, μ}_{BWP, i} common resource blocks starting from the reference point N^{start, μ}_{BWP, i} of the BWP. A BWP configured for a downlink carrier is also referred to as a downlink BWP. A BWP configured for an uplink component carrier is also referred to as an uplink BWP.

An antenna port may be defined such that the channel over which a symbol on the antenna port is conveyed can be inferred from the channel over which another symbol on the same antenna port is conveyed. For example, the channel may correspond to a physical channel. In addition, the symbol may correspond to an OFDM symbol. In addition, the symbol may correspond to a resource block unit. In addition, the symbol may correspond to a resource element.

The fact that a large scale property of a channel over which a symbol on one antenna port is conveyed can be inferred from a channel over which a symbol on another antenna port is conveyed is referred to as the two antenna ports being quasi co-located (QCL). Here, the large scale property may include at least long term property of a channel. The large scale property may include at least a part or all of delay spread, Doppler spread, Doppler shift, an average gain, an average delay, and a beam parameter (spatial Rx parameters). The fact that the first antenna port and the second antenna port are QCL with respect to a beam parameter may mean that a reception beam assumed by a reception side for the first antenna port and a reception beam assumed by the reception unit side for the second antenna port are the same (or the reception beams correspond to each other). The fact that the first antenna port and the second antenna port are QCL with respect to a beam parameter may mean that a transmission beam assumed by a reception side for the first antenna port and a transmission beam assumed by the reception side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL.

Carrier aggregation may mean that communication is performed by using multiple serving cells being aggregated. In addition, carrier aggregation may mean that communication is performed by using multiple component carriers being aggregated. In addition, carrier aggregation may mean that communication is performed by using multiple downlink component carriers being aggregated. In addition, carrier aggregation may mean that communication is performed by using multiple uplink component carriers being aggregated.

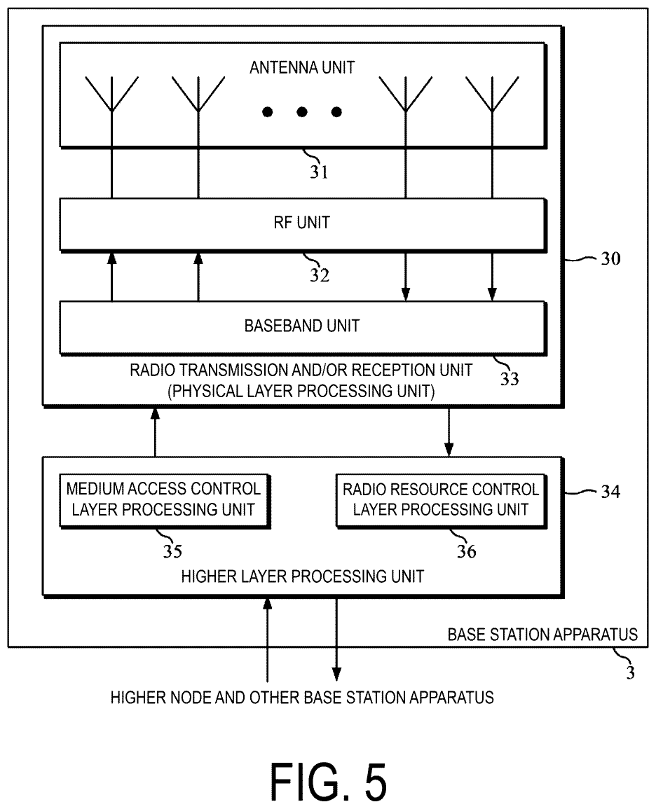

FIG. 5 is a schematic block diagram illustrating a configuration example of the base station apparatus 3 according to an aspect of the present embodiment. As illustrated in FIG. 5, the base station apparatus 3 includes at least a part or all of a radio transmission and/or reception unit (physical layer processing unit) 30 and/or a higher layer processing unit 34. The radio transmission and/or reception unit 30 includes at least a part or all of an antenna unit 31, a radio frequency (RF) unit 32, and a baseband unit 33. The higher layer processing unit 34 includes at least a part or all of a medium access control layer processing unit 35 and a radio resource control (RRC) layer processing unit 36.

The radio transmission and/or reception unit 30 includes at least a part or all of a radio transmission unit 30a and a radio reception unit 30b. Here, apparatus configurations of the baseband unit included in the radio transmission unit 30a and the baseband unit included in the radio reception unit 30b may be the same or different from each other. In addition, apparatus configurations of the RF unit included in the radio transmission unit 30a and the RF unit included in the radio reception unit 30b may be the same or different from each other. In addition, apparatus configurations of the antenna unit included in the radio transmission unit 30a and the antenna unit included in the radio reception unit 30b may be the same or different from each other.

For example, the radio transmission unit 30a may generate and transmit a baseband signal of a PDSCH. For example, the radio transmission unit 30a may generate and transmit a baseband signal of a PDCCH. For example, the radio transmission unit 30a may generate and transmit a baseband signal of a PBCH. For example, the radio transmission unit 30a may generate and transmit a baseband signal of a synchronization signal. For example, the radio transmission unit 30a may generate and transmit a baseband signal of a PDSCH DMRS. For example, the radio transmission unit 30a may generate and transmit a baseband signal of a PDCCH DMRS. For example, the radio transmission unit 30a may generate and transmit a baseband signal of a CSI-RS. For example, the radio transmission unit 30a may generate and transmit a baseband signal of a DL PTRS.

For example, the radio reception unit 30b may receive a PRACH. For example, the radio reception unit 30b may receive and demodulate a PUCCH. The radio reception unit 30b may receive and demodulate a PUSCH. For example, the radio reception unit 30b may receive a PUCCH DMRS. For example, the radio reception unit 30b may receive a PUSCH DMRS. For example, the radio reception unit 30b may receive a UL PTRS. For example, the radio reception unit 30b may receive an SRS.

The higher layer processing unit 34 outputs downlink data (a transport block) to the radio transmission and/or reception unit 30 (or the radio transmission unit 30a). The higher layer processing unit 34 performs processing operations of a Medium Access Control (MAC) layer, a Packet Data Convergence Protocol (PDCP) layer, a Radio Link Control (RLC) layer, and an RRC layer.

The medium access control layer processing unit 35 included in the higher layer processing unit 34 performs processing of the MAC layer. Processing of the MAC layer may be processing of a MAC entity.

The radio resource control layer processing unit 36 included in the higher layer processing unit 34 performs processing of the RRC layer. The radio resource control layer processing unit 36 manages various pieces of configuration information/parameters (RRC parameters) of the terminal apparatus 1. The radio resource control layer processing unit 36 sets the parameter based on an RRC message received from the terminal apparatus 1.

The radio transmission and/or reception unit 30 (or the radio transmission unit 30a) performs processing such as modulation and encoding. The radio transmission and/or reception unit 30 (or the radio transmission unit 30a) generates a physical signal through modulation, encoding, and baseband signal generation (conversion into the time-continuous signal) on downlink data, and transmits the physical signal to the terminal apparatus 1. The radio transmission and/or reception unit 30 (or the radio transmission unit 30a) may map the physical signal to a certain component carrier and transmit the physical signal to the terminal apparatus 1.

The radio transmission and/or reception unit 30 (or the radio reception unit 30b) performs processing such as demodulation and decoding. The radio transmission and/or reception unit 30 (or the radio reception unit 30b) separates, demodulates, and decodes the received physical signal, and outputs the decoded information to the higher layer processing unit 34. The radio transmission and/or reception unit 30 (or the radio reception unit 30b) may perform a channel access procedure prior to transmission of the physical signal.

The RF unit 32 converts (down-converts) a signal received via the antenna unit 31 into a baseband signal by means of orthogonal demodulation and removes unnecessary frequency components. The RF unit 32 outputs a processed analog signal to the baseband unit.

The baseband unit 33 converts an analog signal input from the RF unit 32 into a digital signal. The baseband unit 33 removes a portion corresponding to a cyclic prefix (CP) from the converted digital signal, performs a Fast Fourier Transform (FFT) on the signal from which the CP has been removed, and extracts a signal in the frequency domain.

The baseband unit 33 performs Inverse Fast Fourier Transform (IFFT) on the data to generate an OFDM symbol, adds a CP to the generated OFDM symbol, generates a baseband digital signal, and converts the baseband digital signal into an analog signal. The baseband unit 33 outputs the converted analog signal to the RF unit 32.

The RF unit 32 removes an unnecessary frequency component from the analog signal input from the baseband unit 33 by using a low-pass filter, up-converts the analog signal into a signal having a carrier frequency, and transmits the signal via the antenna unit 31. In addition, the RF unit 32 may have a function of controlling transmission power. The RF unit 32 is also referred to as a transmission power control unit.

For the terminal apparatus 1, one or multiple serving cells (or component carriers, downlink component carriers, uplink component carriers) may be configured.

Each of the serving cells configured for the terminal apparatus 1 may be one of a Primary cell (PCell), a Primary SCG cell (PSCell), or a Secondary Cell (SCell). An SpCell may be one or both of a PCell and a PSCell.

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which random access is performed by the terminal apparatus 1.

The SCell may be included in either of the MCG or the SCG.

A serving cell group (cell group) is a term at least including an MCG and an SCG. The serving cell group may include one or multiple serving cells (or component carriers). One or multiple serving cells (or component carriers) included in the serving cell group may be operated by means of carrier aggregation.

One or multiple downlink BWPs may be configured for each of the serving cells (or downlink component carriers). One or multiple uplink BWPs may be configured for each of the serving cells (or uplink component carriers).

Among one or multiple downlink BWPs configured for the serving cell (or the downlink component carrier), one downlink BWP may be configured as an active downlink BWP (or one downlink BWP may be activated). Among one or multiple uplink BWPs configured for the serving cell (or the uplink component carrier), one uplink BWP may be configured as an active uplink BWP (or one uplink BWP may be activated).

The PDSCH, the PDCCH, and the CSI-RS may be received in the active downlink BWP. The terminal apparatus 1 may attempt to receive the PDSCH, the PDCCH, and the CSI-RS in the active downlink BWP. The PUCCH and the PUSCH may be transmitted in the active uplink BWP. The terminal apparatus 1 may transmit the PUCCH and the PUSCH in the active uplink BWP. The active downlink BWP and the active uplink BWP are also collectively referred to as active BWPs.

The PDSCH, the PDCCH, and the CSI-RS need not be received in downlink BWPs (inactive downlink BWPs) other than the active downlink BWP. The terminal apparatus 1 need not attempt to receive the PDSCH, the PDCCH, and the CSI-RS in downlink BWPs that are not active downlink BWPs. The PUCCH and the PUSCH need not be transmitted in uplink BWPs (inactive uplink BWPs) that are not active uplink BWPs. The terminal apparatus 1 need not transmit the PUCCH and the PUSCH in uplink BWPs that are not active uplink BWPs. The inactive downlink BWPs and the inactive uplink BWPs are also collectively referred to as inactive BWPs.

Downlink BWP switch is a procedure for deactivating one active downlink BWP of a certain serving cell and activating any one of the inactive downlink BWPs of the certain serving cell. The downlink BWP switch may be controlled by a BWP field included in downlink control information. The downlink BWP switch may be controlled based on a higher layer parameter.

Uplink BWP switch is used for deactivating one active uplink BWP and activating any one of the inactive uplink BWPs that are not the one active uplink BWP. The uplink BWP switch may be controlled by a BWP field included in downlink control information. The uplink BWP switch may be controlled based on a higher layer parameter.

Among one or multiple downlink BWPs configured for the serving cell, two or more downlink BWPs need not be configured for an active downlink BWP. For the serving cell, at certain times, one downlink BWP may be active.

Among one or multiple uplink BWPs configured for the serving cell, two or more uplink BWPs need not be configured for an active uplink BWP. For the serving cell, at certain times, one uplink BWP may be active.

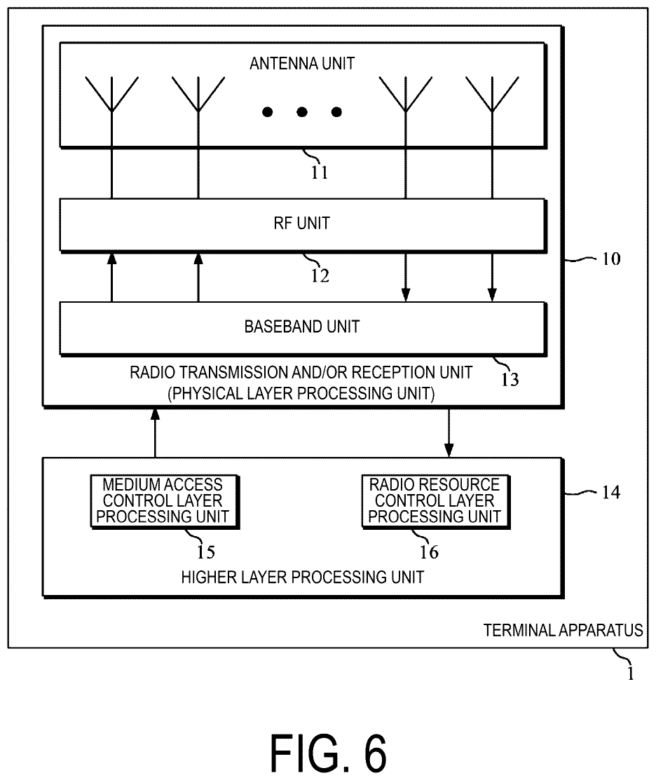

FIG. 6 is a schematic block diagram illustrating a configuration example of the terminal apparatus 1 according to an aspect of the present embodiment. As illustrated in FIG. 6, the terminal apparatus 1 includes at least one or all of a radio transmission and/or reception unit (physical layer processing unit) 10 and a higher layer processing unit 14. The radio transmission and/or reception unit 10 includes at least a part or all of an antenna unit 11, an RF unit 12, and a baseband unit 13. The higher layer processing unit 14 includes at least a part or all of a medium access control layer processing unit 15 and a radio resource control layer processing unit 16.

The radio transmission and/or reception unit 10 includes at least a part or all of a radio transmission unit 10a and a radio reception unit 10b. Here, apparatus configurations of the baseband unit 13 included in the radio transmission unit 10a and the baseband unit 13 included in the radio reception unit 10b may be the same or different from each other. In addition, apparatus configurations of the RF unit 12 included in the radio transmission unit 10a and the RF unit 12 included in the radio reception unit 10b may be the same or different from each other. In addition, apparatus configurations of the antenna unit 11 included in the radio transmission unit 10a and the antenna unit 11 included in the radio reception unit 10b may be the same or different from each other.

For example, the radio transmission unit 10a may generate and transmit a baseband signal of a PRACH. For example, the radio transmission unit 10a may generate and transmit a baseband signal of a PUCCH. The radio transmission unit 10a may generate and transmit a baseband signal of a PUSCH. For example, the radio transmission unit 10a may generate and transmit a baseband signal of a PUCCH DMRS. For example, the radio transmission unit 10a may generate and transmit a baseband signal of a PUSCH DMRS. For example, the radio transmission unit 10a may generate and transmit a baseband signal of a UL PTRS. For example, the radio transmission unit 10a may generate and transmit a baseband signal of an SRS. Generating the baseband signal of the SRS may be generating an SRS sequence.

For example, the radio reception unit 10b may receive and demodulate a PDSCH. For example, the radio reception unit 10b may receive and demodulate a PDCCH. For example, the radio reception unit 10b may receive and demodulate a PBCH. For example, the radio reception unit 10b may receive a synchronization signal. For example, the radio reception unit 10b may receive a PDSCH DMRS. For example, the radio reception unit 10b may receive a PDCCH DMRS. For example, the radio reception unit 10b may receive a CSI-RS. For example, the radio reception unit 10b may receive a DL PTRS.

The higher layer processing unit 14 outputs uplink data (a transport block) to the radio transmission and/or reception unit 10 (or the radio transmission unit 10a). The higher layer processing unit 14 performs processing operations of the MAC layer, a packet data convergence protocol layer, a radio link control layer, and the RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various pieces of configuration information/parameters (RRC parameters) of the terminal apparatus 1. The radio resource control layer processing unit 16 sets the RRC parameters based on an RRC message received from the base station apparatus 3.

The radio transmission and/or reception unit 10 (or the radio transmission unit 10a) performs processing such as modulation and encoding. The radio transmission and/or reception unit 10 (or the radio transmission unit 10a) generates a physical signal through modulation, encoding, and baseband signal generation (conversion into a time-continuous signal) on uplink data and transmits the physical signal to the base station apparatus 3. The radio transmission and/or reception unit 10 (or the radio transmission unit 10a) may map the physical signal to a certain BWP (an active uplink BWP) and transmit the physical signal to the base station apparatus 3.

The radio transmission and/or reception unit 10 (or the radio reception unit 10b) performs processing such as demodulation and decoding. The radio transmission and/or reception unit 10 (or the radio reception unit 30b) may receive a physical signal in a certain BWP (active downlink BWP) of a certain serving cell. The radio transmission and/or reception unit 10 (or the radio reception unit 10b) separates, demodulates, and decodes the received physical signal and outputs the decoded information to the higher layer processing unit 14. The radio transmission and/or reception unit 10 (radio reception unit 10b) may perform the channel access procedure prior to the transmission of the physical signal.

The RF unit 12 converts (down-converts) a signal received via the antenna unit 11 into a baseband signal by means of orthogonal demodulation and removes unnecessary frequency components. The RF unit 12 outputs a processed analog signal to the baseband unit 13.

The baseband unit 13 converts the analog signal input from the RF unit 12 into a digital signal. The baseband unit 13 removes a portion corresponding to a cyclic prefix (CP) from the converted digital signal, performs a Fast Fourier Transform (FFT) on the signal from which the CP has been removed, and extracts a signal of the frequency domain.

The baseband unit 13 performs an Inverse Fast Fourier Transform (IFFT) on the uplink data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 by using a low-pass filter, up-converts the analog signal into a signal having a carrier frequency, and transmits the signal via the antenna unit 11. In addition, the RF unit 12 may have a function of controlling transmission power. The RF unit 12 is also referred to as a transmission power control unit.

A physical signal (signal) will be described below.

A physical signal is a general term for a downlink physical channel, a downlink physical signal, an uplink physical channel, and an uplink physical channel. A physical channel is a general term for a downlink physical channel and an uplink physical channel. A physical signal is a general term for a downlink physical signal and an uplink physical signal.

An uplink physical channel may correspond to a set of resource elements for conveying information that is generated in a higher layer. An uplink physical channel may be a physical channel used in an uplink component carrier. An uplink physical channel may be transmitted by the terminal apparatus 1. The uplink physical channel may be received by the base station apparatus 3. In the radio communication system according to an aspect of the present embodiment, at least a part or all of the following uplink physical channels may be used:
Physical Uplink Control CHannel (PUCCH);
Physical Uplink Shared CHannel (PUSCH); and
Physical Random Access CHannel (PRACH).

The PUCCH may be used to transmit Uplink Control Information (UCI). The PUCCH may be transmitted for conveying (delivering or transmitting) uplink control information. The uplink control information may be mapped to the PUCCH. The terminal apparatus 1 may transmit the PUCCH to which the uplink control information is mapped. The base station apparatus 3 may receive the PUCCH to which the uplink control information is mapped.

The uplink control information (uplink control information bit, uplink control information sequence, or uplink control information type) includes at least a part or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include at least a HARQ-ACK corresponding to a transport block (TB). The HARQ-ACK may indicate an acknowledgement (ACK) or a negative-acknowledgement (NACK) corresponding to the transport block. The ACK may indicate that decoding of the transport block has been decoded successfully. The NACK may indicate that decoding of the transport block has not been decoded successfully. The HARQ-ACK information may include a HARQ-ACK codebook including one or multiple HARQ-ACK bits.

The transport block is a sequence of information bits delivered from a higher layer. Here, the sequence of information bits is also referred to as a bit sequence. Here, the transport block may be delivered through an uplink-shared channel (UL-SCH) of a transport layer.

A HARQ-ACK for the transport block may be referred to as a HARQ-ACK for a PDSCH. In this case, the “HARQ-ACK for the PDSCH” indicates a HARQ-ACK for a transport block included in a PDSCH.

The HARQ-ACK may indicate an ACK or a NACK corresponding to one code block group (CBG) included in the transport block.

A scheduling request may be at least used for requesting a resource of the UL-SCH for new transmission. A scheduling request bit may be used for indicating either of a positive SR or a negative SR. The scheduling request bit indicating the positive SR is also referred to as a “positive SR being conveyed”. The positive SR may indicate that the terminal apparatus 1 requests resources of the UL-SCH for new transmission. The positive SR may indicate that a scheduling request is triggered by a higher layer. The positive SR may be conveyed in a case that the higher layer indicates the scheduling request. The scheduling request bit indicating the negative SR is also referred to as a “negative SR being transmitted”. The negative SR may indicate that the terminal apparatus 1 requests no resources of the UL-SCH for new transmission. The negative SR may indicate that the scheduling request is not triggered by a higher layer. The negative SR may be conveyed in a case that the higher layer indicates no scheduling request.

Channel state information may include at least a part or all of a Channel Quality Indicator (CQI), a Precoder Matrix Indicator (PMI), and a Rank Indicator (RI). The CQI is an indicator related to quality (for example, propagation strength) of a propagation path or quality of a physical channel, and the PMI is an indicator related to a precoder. The RI is an indicator related to a transmission rank (or the number of transmission layers).

The channel state information is an indicator related to a reception state of a physical signal (for example, CSI-RS) at least used for channel measurement. A value of the channel state information may be determined by the terminal apparatus 1 based on the reception state assumed by a physical signal at least used for channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH may be transmitted in a certain PUCCH format. Note that the PUCCH format may be interpreted as a form of information. In addition, the PUCCH format may be interpreted as a set of information set in a certain form of information.

The PUSCH may be used for conveying one or both of a transport block and uplink control information. The transport block may be mapped to the PUSCH. The transport block delivered on the UL-SCH may be mapped to the PUSCH. The uplink control information may be mapped to the PUSCH. The terminal apparatus 1 may transmit the PUSCH to which one or both of the transport block and the uplink control information are mapped. The base station apparatus 3 may receive the PUSCH to which one or both of the transport block and the uplink control information are mapped.

The PRACH may be transmitted for conveying a random access preamble. The terminal apparatus 1 may transmit the PRACH. The base station apparatus 3 may receive the PRACH. A PRACH sequence x_{u, v}(n) is defined by x_{u, v}(n)=xᵤ(mod(n+Cᵥ, L_{RA})). Here, xᵤ is a Zadoff Chu (ZC) sequence. In addition, xᵤ may be defined by xᵤ=exp (−jπui(i+1)/L_{RA}). j is an imaginary unit. In addition, x is the ratio of the circumference of a circle to its diameter. In addition, Cᵥ corresponds to a cyclic shift of the PRACH sequence. In addition, L_{RA} corresponds to the length of the PRACH sequence. In addition, L_{RA} is 839, or 139. In addition, i is an integer in the range from 0 to L_{RA}−1. In addition, u is a sequence index for the PRACH sequence.

For each PRACH occasion, 64 random access preambles are defined. The random access preambles are identified based on the cyclic shift Cᵥ of the PRACH sequence and the sequence index u for the PRACH sequence. Each of the 64 identified random access preambles may be assigned an index.

Uplink physical signals may correspond to a set of resource elements. The uplink physical signals need not be used to convey information generated in a higher layer. Note that the uplink physical signals may be used to convey information generated in the physical layer. The uplink physical signals may be physical signals used in an uplink component carrier. The terminal apparatus 1 may transmit the uplink physical signals. The base station apparatus 3 may receive the uplink physical signals. In the radio communication system according to an aspect of the present embodiment, at least a part or all of the following uplink physical signals may be used:
UpLink Demodulation Reference Signal (UL DMRS);
Sounding Reference Signal (SRS); and
UpLink Phase Tracking Reference Signal (UL PTRS).

A UL DMRS is a general term for a DMRS for a PUSCH and a DMRS for a PUCCH.

A set of antenna ports of the DMRS for the PUSCH (the DMRS related to the PUSCH, the DMRS included in the PUSCH, or the DMRS corresponding to the PUSCH) may be given based on a set of antenna ports for the PUSCH. For example, the set of antenna ports of the DMRS for the PUSCH may be the same as a set of antenna ports of the PUSCH.

Transmission of the PUSCH and transmission of the DMRS for the PUSCH may be indicated (or may be scheduled) in one DCI format. The PUSCH and the DMRS for the PUSCH may be collectively referred to as a PUSCH. Transmission of the PUSCH may mean transmission of the PUSCH and the DMRS for the PUSCH.

A propagation path of the PUSCH may be inferred from the DMRS for the PUSCH.

A set of antenna ports of the DMRS for the PUCCH (a DMRS related to the PUCCH, a DMRS included in the PUCCH, or a DMRS corresponding to the PUCCH) may be the same as a set of antenna ports of the PUCCH.

Transmission of the PUCCH and transmission of the DMRS for the PUCCH may be indicated (or may be triggered) in one DCI format. One or both of resource element mapping of the PUCCH and resource element mapping of the DMRS for the PUCCH may be given in one PUCCH format. The PUCCH and the DMRS for the PUCCH may be collectively referred to as a PUCCH. Transmission of the PUCCH may mean transmission of the PUCCH and the DMRS for the PUCCH.

A propagation path of the PUCCH may be inferred from the DMRS for the PUCCH.

A downlink physical channel may correspond to a set of resource elements for conveying information generated in a higher layer. A downlink physical channel may be a physical channel used in a downlink component carrier. The base station apparatus 3 may transmit a downlink physical channel. The terminal apparatus 1 may receive a downlink physical channel. In the radio communication system according to an aspect of the present embodiment, at least a part or all of the following downlink physical channels may be used:
Physical Broadcast Channel (PBCH);
Physical Downlink Control Channel (PDCCH); and
Physical Downlink Shared Channel (PDSCH).

The PBCH may be transmitted for conveying one or both of a Master Information Block (MIB) and physical layer control information. Here, the physical layer control information is information generated in the physical layer. The MIB is a set of parameters mapped to a Broadcast Control CHannel (BCCH) that is a logical channel of the MAC layer. The BCCH is mapped to a BCH that is a channel of a transport layer. The BCH may be mapped to the PBCH. The terminal apparatus 1 may receive the PBCH to which one or both of the MIB and the physical layer control information are mapped. The base station apparatus 3 may transmit the PBCH to which one or both of the MIB and/or the physical layer control information are mapped.

For example, the physical layer control information may include 8 bits. The physical layer control information may include at least a part or all of the following 0A to 0D.
0A) Radio frame bits
0B) Half radio frame (half system frame or half frame) bits
0C) SS/PBCH block index bits
0D) Subcarrier offset bits

The radio frame bit is used for indicating a radio frame in which the PBCH is transmitted (radio frame including a slot in which the PBCH is transmitted). The radio frame bit includes 4 bits. The radio frame bit may include 4 bits out of a 10-bit radio frame indicator. For example, the radio frame indicator may be at least used for identifying radio frames from index 0 to index 1023.

The half radio frame bit is used for indicating, out of the radio frame in which the PBCH is transmitted, which of the first five subframes or the last five subframes is used for transmission of the PBCH. Here, the half radio frame may include five subframes. In addition, the half radio frame may include the first five subframes out of the 10 subframes included in the radio frame. In addition, the half radio frame may include the last five subframes out of the 10 subframes included in the radio frame.

An SS/PBCH block index bit is used for indicating an SS/PBCH block index. The SS/PBCH block index bit includes 3 bits. The SS/PBCH block index bit may include 3 bits out of a 6-bit SS/PBCH block index indicator. The SS/PBCH block index indicator may be at least used for identifying SS/PBCH blocks of the index 0 to index 63. The SS/PBCH block may also be referred to as an SSB.

A subcarrier offset bit is used for indicating a subcarrier offset. The subcarrier offset may be used for indicating a difference between the leading subcarrier to which the PBCH is mapped and the leading subcarrier to which the control resource set having the index 0 is mapped.

The PDCCH may be transmitted for transmitting Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted in a DCI format. Note that the DCI format may also be interpreted to be in the format of downlink control information. In addition, the DCI format may be interpreted as a set of downlink control information set to the format of certain downlink control information.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is at least used for scheduling of the PUSCH mapped to a certain cell. The DCI format 0_0 includes at least a part or all of fields listed from 1A to 1E.
1A) Identifier field for DCI formats
1B) Frequency domain resource assignment field
1C) Time domain resource assignment field
1D) Frequency hopping flag field
1E) Modulation and Coding Scheme (MCS) field

An identifier field for DCI formats may indicate whether the DCI format including the identifier field for DCI formats is an uplink DCI format or a downlink DCI format. In other words, an identifier field for DCI formats may be included in each of the uplink DCI format and the downlink DCI format. Here, the identifier field for DCI formats included in the DCI format 0_0 may indicate 0.

A frequency domain resource assignment field included in the DCI format 0_0 may be used for indicating assignment of frequency resources for the PUSCH.

A time domain resource assignment field included in the DCI format 0_0 may be used for indicating assignment of time resources for the PUSCH.

A frequency hopping flag field may be used for indicating whether frequency hopping is applied to the PUSCH.

An MCS field included in the DCI format 0_0 may be at least used for indicating one or both of a modulation scheme for the PUSCH and a target encoding rate. The target encoding rate may be a target encoding rate for the transport block mapped to the PUSCH. A transport block size (TBS) mapped to the PUSCH may be determined based on one or both of the target encoding rate and the modulation scheme for the PUSCH.

The DCI format 0_0 need not include a field used for a CSI request.

The DCI format 0_0 need not include a carrier indicator field. In other words, the serving cell to which the uplink component carrier to which the PUSCH scheduled in the DCI format 0_0 is mapped belongs may be the same as the serving cell of the uplink component carrier to which the PDCCH including the DCI format 0_0 is mapped. Based on detection of the DCI format 0_0 in a certain downlink component carrier of a certain serving cell, the terminal apparatus 1 may recognize that the PUSCH scheduled in the DCI format 0_0 is mapped to the uplink component carrier of the certain serving cell.

The DCI format 0_0 need not include a BWP field. Here, the DCI format 0_0 may be a DCI format for scheduling the PUSCH without changing an active uplink BWP. The terminal apparatus 1 may recognize that the PUSCH is transmitted without switching the active uplink BWP based on detection of the DCI format 0_0 used for the scheduling of the PUSCH.

The DCI format 0_1 is at least used for scheduling of the PUSCH mapped to a certain cell. The DCI format 0_1 includes at least a part or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 0_1 may be used for indicating assignment of frequency resources for the PUSCH.

The time domain resource assignment field included in the DCI format 0_1 may be used for indicating assignment of time resources for the PUSCH.

The MCS field included in the DCI format 0_1 may be at least used for indicating a part or all of a modulation scheme for the PUSCH and/or a target encoding rate.

The BWP field of the DCI format 0_1 may be used for indicating an uplink BWP to which the PUSCH scheduled in the DCI format 0_1 is mapped. In other words, the DCI format 0_1 may be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of the DCI format D0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may ignore the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

The CSI request field is used for indicating a report of CSI.

In a case that a carrier indicator field is included in the DCI format 0_1, the carrier indicator field may be used for indicating the uplink component carrier to which the PUSCH is mapped. In a case that a carrier indicator field is not included in the DCI format 0_1, the uplink component carrier to which the PUSCH is mapped may be the same as the uplink component carrier to which the PDCCH including the DCI format 0_1 used for scheduling of the PUSCH is mapped. In a case that the number of uplink component carriers configured for the terminal apparatus 1 in a certain serving cell group is two or more (a case that uplink carrier aggregation is operated in a certain serving cell group), the number of bits of the carrier indicator field included in the DCI format 0_1 used for scheduling of the PUSCH mapped to the certain serving cell group may be 1 bit or more (for example, 3 bits). In a case that the number of uplink component carriers configured for the terminal apparatus 1 in a certain serving cell group is one (a case that uplink carrier aggregation is not operated in a certain serving cell group), the number of bits of the carrier indicator field included in the DCI format 0_1 used for scheduling of the PUSCH mapped to the certain serving cell group may be 0 bits (or the carrier indicator field need not be included in the DCI format 0_1 used for scheduling of the PUSCH mapped to the certain serving cell group).

The DCI format 1_0 is at least used for scheduling of the PDSCH mapped to a certain cell. The DCI format 1_0 includes at least a part or all of 3A to 3F:
3A) Identifier field for DCI formats;
3B) Frequency domain resource assignment field;
3C) Time domain resource assignment field;
3D) MCS field;
3E) PDSCH_HARQ feedback timing indicator field (PDSCH to HARQ feedback timing indicator field); and 3F) PUCCH resource indicator field.

The identifier field for DCI formats included in the DCI format 1_0 may indicate 1.

The frequency domain resource assignment field included in the DCI format 1_0 may be at least used for indicating assignment of frequency resources for the PDSCH.

The time domain resource assignment field included in the DCI format 1_0 may be at least used for indicating assignment of time resources for the PDSCH.

The MCS field included in the DCI format 1_0 may be at least used for indicating one or both of the modulation scheme for the PDSCH and the target encoding rate. The target encoding rate may be a target encoding rate for a transport block mapped to the PDSCH. The size of a transport block (Transport Block Size or TBS) mapped to the PDSCH may be determined based on one or both of the target encoding rate and the modulation scheme for the PDSCH.

The PDSCH_HARQ feedback timing indicator field may be used for indicating an offset from the slot including the last OFDM symbol of the PDSCH to the slot including the first OFDM symbol of the PUCCH.

The PUCCH resource indicator field may be a field indicating an index of any of one or multiple PUCCH resources included in a PUCCH resource set. The PUCCH resource set may include one or multiple PUCCH resources.

The DCI format 1_0 need not include the carrier indicator field. In other words, the downlink component carrier to which the PDSCH scheduled by using the DCI format 1_0 is mapped may be the same as the downlink component carrier to which the PDCCH including the DCI format 1_0 is mapped. Based on detection of the DCI format 1_0 on a certain downlink component carrier, the terminal apparatus 1 may recognize that the PDSCH scheduled in the DCI format 1_0 is mapped to the downlink component carrier.

The DCI format 1_0 need not include a BWP field. Here, DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in scheduling of the PDSCH.

The DCI format 1_1 is at least used for scheduling of the PDSCH mapped to a certain cell. The DCI format 1_1 includes at least some or all of 4A to 4I:
4A) Identifier field for DCI formats;
4B) Frequency domain resource assignment field;
4C) Time domain resource assignment field;
4E) MCS field;
4F) PDSCH_HARQ feedback timing indicator field;
4G) PUCCH resource indicator field;
4H) BWP field; and
4I) Carrier indicator field.

The identifier field for DCI formats included in the DCI format 1_1 may indicate 1.

The frequency domain resource assignment field included in the DCI format 1_1 may be at least used for indicating assignment of frequency resources for the PDSCH.

The time domain resource assignment field included in the DCI format 1_1 may be at least used for indicating assignment of time resources for the PDSCH.

The MCS field included in the DCI format 1_1 may be at least used for indicating one or both of the modulation scheme for the PDSCH and the target encoding rate.

In a case that the PDSCH_HARQ feedback timing indicator field is included in the DCI format 1_1, the PDSCH_HARQ feedback timing indicator field may be at least used for indicating an offset from the slot including the last OFDM symbol of the PDSCH to the slot including the first OFDM symbol of the PUCCH. In a case that the PDSCH_HARQ feedback timing indicator field is not included in the DCI format 1_1, an offset from the slot including the last OFDM symbol of the PDSCH to the slot including the first OFDM symbol of the PUCCH may be identified by a higher layer parameter.

The PUCCH resource indicator field may be a field indicating an index of any of one or multiple PUCCH resources included in a PUCCH resource set.

The BWP field of the DCI format 1_1 may be used to indicate the downlink BWP to which the PDSCH scheduled in the DCI format 1_1 is mapped. In other words, the DCI format 1_1 may be accompanied by a change in the active downlink BWP. The terminal apparatus 1 may recognize the downlink BWP to which the PUSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and the DCI format 1_1 not including the BWP field.

In a case that the DCI format 1_1 includes the BWP field but the terminal apparatus 1 does not support the function of switching the BWP according to the DCI format 1_1, the terminal apparatus 1 may ignore the BWP field. In other words, the terminal apparatus 1 which does not support the function of switching the BWP may recognize that the PDSCH is received without switching the active downlink BWP based on detection of the DCI format 1_1 which is used for the scheduling of the PDSCH and the DCI format 1_1 including the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

In a case that the carrier indicator field is included in the DCI format 1_1, the carrier indicator field may be used for indicating the downlink component carrier to which the PDSCH is mapped. In a case that the carrier indicator field is not included in the DCI format 1_1, the downlink component carrier to which the PDSCH is mapped may be the same as the downlink component carrier to which the PDCCH including the DCI format 1_1 used for scheduling of the PDSCH is mapped. In a case that the number of downlink component carriers configured for the terminal apparatus 1 in a certain serving cell group is two or more (a case that downlink carrier aggregation is operated in a certain serving cell group), the number of bits of the carrier indicator field included in the DCI format 1_1 used for scheduling of the PDSCH mapped to the certain serving cell group may be 1 bit or more (for example, 3 bits). In a case that the number of downlink component carriers configured for the terminal apparatus 1 in a certain serving cell group is one (a case that downlink carrier aggregation is not operated in a certain serving cell group), the number of bits of the carrier indicator field included in the DCI format 1_1 used for scheduling of the PDSCH mapped to the certain serving cell group may be 0 bits (or the carrier indicator field need not be included in the DCI format 1_1 used for scheduling of the PDSCH mapped to the certain serving cell group).

The PDSCH may be transmitted for conveying a transport block. The PDSCH may be used for transmitting a transport block delivered on the DL-SCH. The PDSCH may be used for conveying a transport block. A transport block may be mapped to the PDSCH. The transport block corresponding to the DL-SCH may be mapped to the PDSCH. The base station apparatus 3 may transmit the PDSCH. The terminal apparatus 1 may receive the PDSCH.

A downlink physical signal may correspond to a set of resource elements. The downlink physical signal need not convey information generated in a higher layer. The downlink physical signal may be a physical signal used in a downlink component carrier. The downlink physical signal may be transmitted by the base station apparatus 3. The downlink physical signal may be transmitted by the terminal apparatus 1. In the radio communication system according to an aspect of the present embodiment, at least some or all of the following downlink physical signals may be used:
Synchronization signal (SS);
DownLink DeModulation Reference Signal (DL DMRS);
Channel State Information-Reference Signal (CSI-RS); and
DownLink Phase Tracking Reference Signal (DL PTRS).

The synchronization signal may be used for the terminal apparatus 1 to take synchronization in one or both of the frequency domain and the time domain in downlink. The synchronization signal is a general term for a primary synchronization signal (PSS) and a secondary synchronization signal (SSS).

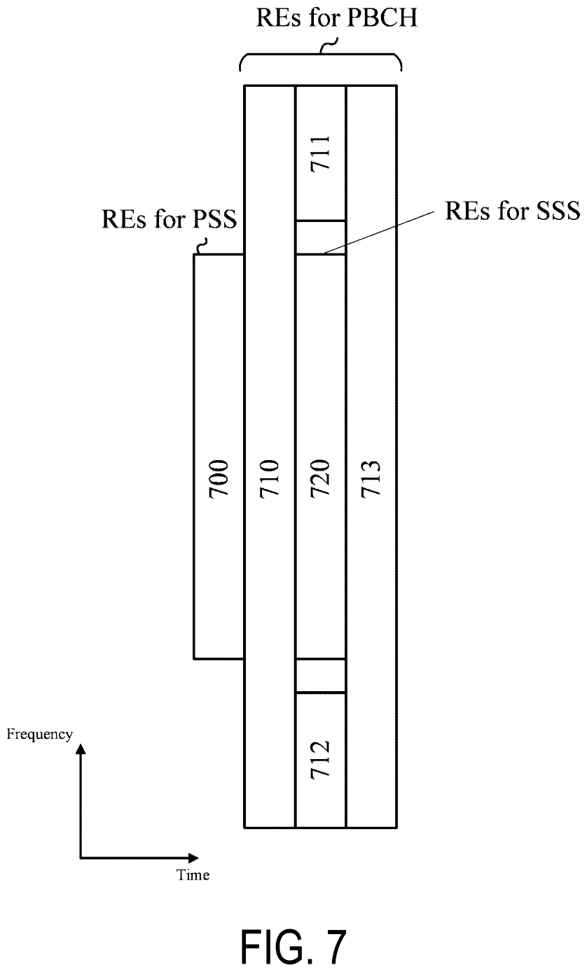

FIG. 7 is a diagram illustrating a configuration example of the SS/PBCH block according to an aspect of the present embodiment. In FIG. 7, the horizontal axis corresponds to a time axis (OFDM symbol index l_{sym}), and the vertical axis represents the frequency domain. In addition, a block 700 represents a set of resource elements for a PSS. In addition, a block 720 represents a set of resource elements for an SSS. In addition, four blocks (blocks 710, 711, 712, and 713) represent a set of resource elements for a PBCH and a DMRS for the PBCH (DMRS related to the PBCH, DMRS included in the PBCH, or DMRS corresponding to the PBCH).

As illustrated in FIG. 7, the SS/PBCH block includes a PSS, an SSS, and a PBCH. In addition, the SS/PBCH block includes four consecutive OFDM symbols. The SS/PBCH block includes 240 subcarriers. The PSS is mapped to the 57th to 183rd subcarriers in the first OFDM symbol. The SSS is mapped to the 57th to 183rd subcarriers in the third OFDM symbol. Zero may be set to the 1st to 56th subcarriers of the first OFDM symbol. Zero may be set to the 184th to 240th subcarriers of the first OFDM symbol. Zero may be set to the 49th to 56th subcarriers of the third OFDM symbol. Zero may be set to the 184th to 192nd subcarriers of the third OFDM symbol. The PBCH is mapped to subcarriers which are the 1st to 240th subcarriers of the second OFDM symbol and to which a DMRS for the PBCH is not mapped. The PBCH is mapped to subcarriers which are the 1st to 48th subcarriers of the third OFDM symbol and to which a DMRS for the PBCH is not mapped. The PBCH is mapped to subcarriers which are the 193rd to 240th subcarriers of the third OFDM symbol and to which a DMRS for the PBCH is not mapped. The PBCH is mapped to subcarriers which are the 1st to 240th subcarriers of the fourth OFDM symbol and to which a DMRS for the PBCH is not mapped.

The antenna ports of the PSS, the SSS, the PBCH, and the DMRS for the PBCH may be the same.

The PBCH over which the symbol of the PBCH on a certain antenna port is conveyed may be inferred from the DMRS for the PBCH mapped to the slot to which the PBCH is mapped and the DMRS for the PBCH included in the SS/PBCH block including the PBCH.

The DL DMRS is a general term for a DMRS for the PBCH, a DMRS for the PDSCH, and a DMRS for the PDCCH.

A set of antenna ports of the DMRS for the PDSCH (a DMRS related to the PDSCH, a DMRS included in the PDSCH, or a DMRS corresponding to the PDSCH) may be given based on a set of antenna ports for the PDSCH. In other words, the set of antenna ports of the DMRS for the PDSCH may be the same as the set of antenna ports for the PDSCH.

Transmission of the PDSCH and transmission of the DMRS for the PDSCH may be indicated (or may be scheduled) in one DCI format. The PDSCH and the DMRS for the PDSCH may be collectively referred to as a PDSCH. Transmission of the PDSCH may be transmission of the PDSCH and the DMRS for the PDSCH.

A propagation path of the PDSCH may be inferred from the DMRS for the PDSCH. In a case that a set of resource elements in which the symbol of a certain PDSCH is conveyed and a set of resource elements in which the symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (the DMRS related to the PDCCH, the DMRS included in the PDCCH, or the DMRS corresponding to the PDCCH) may be the same as the antenna port for the PDCCH.

The PDCCH may be inferred from the DMRS for the PDCCH. In other words, a propagation path of the PDCCH may be inferred from the DMRS for the PDCCH. In a case that the same precoder is (assumed to be) applied to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an Uplink-Shared CHannel (UL-SCH), and a Downlink-Shared CHannel (DL-SCH) are transport channels. A transport channel defines the relationship between a physical layer channel and a MAC layer channel (also referred to as a logical channel).

A BCH of the transport layer is mapped to the PBCH of the physical layer. In other words, a transport block passing through the BCH of the transport layer is delivered to the PBCH of the physical layer. In addition, the UL-SCH of the transport layer is mapped to the PUSCH of the physical layer. In other words, the transport block passing through the UL-SCH of the transport layer is delivered to the PUSCH of the physical layer. In addition, the DL-SCH of the transport layer is mapped to the PDSCH of the physical layer. In other words, a transport block passing through the DL-SCH of the transport layer is delivered to the PDSCH of the physical layer.

One UL-SCH and one DL-SCH may be given to each serving cell. The BCH may be given to a PCell. The BCH need not be given to a PSCell and an SCell.

In the MAC layer, control over a Hybrid Automatic Repeat reQuest (HARQ) is performed for each transport block.

A Broadcast Control CHannel (BCCH), a Common Control CHannel (CCCH), and a Dedicated Control CHannel (DCCH) are logical channels. For example, the BCCH is a channel of the RRC layer used for transmitting a MIB or system information. In addition, a Common Control CHannel (CCCH) may be used for transmitting a common RRC message in multiple terminal apparatuses 1. Here, the CCCH may be, for example, used for a terminal apparatus 1 that is not in a state of RRC connection. In addition, a Dedicated Control CHannel (DCCH) may be at least used for transmitting an RRC message dedicated to a terminal apparatus 1. Here, the DCCH may be, for example, used for the terminal apparatus 1 that is in a state of RRC connection.

For example, System Information (SI) may be configured with the MIB and several System Information blocks (SIBs). In addition, the system information may be divided into Minimum SI and Other SI. The Minimum SI may include basic information required for initial access. Further, the Minimum SI may include information for acquiring the Other SI. The Minimum SI may include a MIB and a SIB1. The Other SI may include all SIBs that are not broadcast in the Minimum SI. These SIBs may be broadcast or transmitted in the DL-SCH.

The SIB1 may define scheduling of Other SI. The SIB1 may include information needed for initial access. The SIB1 may be referred to as a Remaining Minimum SI (RMSI). The SIB1 may be left periodically on the DL-SCH. The SIB1 may be transmitted in a dedicated manner on the DL-SCH to some pieces of UE in an RRC_CONNECTED state.

A higher layer parameter common to multiple terminal apparatuses 1 is also referred to as a common higher layer parameter. Here, the common higher layer parameter may be defined as a parameter specific to a serving cell. Here, a parameter specific to a serving cell may be a parameter common to terminal apparatuses configured with the serving cell (for example, terminal apparatuses 1-A, 1-B, and 1-C).

For example, an RRC message delivered to the BCCH may include the common higher layer parameter. For example, an RRC message delivered on the DCCH may include the common higher layer parameter.

Among certain higher layer parameters, a higher layer parameter different from the common higher layer parameter is also referred to as a dedicated higher layer parameter. Here, the dedicated higher layer parameter can provide a dedicated RRC parameter to the terminal apparatus 1-A configured with the serving cell. In other words, the dedicated RRC parameter is a higher layer parameter capable of providing a unique configuration to each of the terminal apparatuses 1-A, 1-B, and 1-C.

The BCCH of the logical channel may be mapped to the BCH or the DL-SCH of the transport layer. For example, a transport block including information of a MIB is delivered to the BCH of the transport layer. In addition, a transport block including system information other than the MIB is delivered to the DL-SCH of the transport layer. In addition, the CCCH is mapped to the DL-SCH or the UL-SCH. In other words, a transport block mapped to the CCCH is delivered to the DL-SCH or the UL-SCH. In addition, the DCCH is mapped to the DL-SCH or the UL-SCH. In other words, a transport block mapped to the DCCH is delivered to the DL-SCH or the UL-SCH.

An RRC message includes one or multiple parameters managed in the RRC layer. Here, the parameters managed in the RRC layer are also referred to as RRC parameters. For example, the RRC message may include the MIB. In addition, the RRC message may include system information. In addition, the RRC message may include a message corresponding to the CCCH. In addition, the RRC message may include a message corresponding to the DCCH. An RRC message including a message corresponding to the DCCH is also referred to as an individual RRC message.

A higher layer parameter (a parameter of a higher layer) is an RRC parameter or a parameter included in a Medium Access Control Control Element (MAC CE). In other words, the higher layer parameter is a general term for the MIB, the system information, a message corresponding to the CCCH, a message corresponding to the DCCH, and a parameter included in a MAC CE. The parameter included in the MAC CE is transmitted by using a MAC Control Element (CE) command.

Procedures performed by the terminal apparatus 1 include at least some or all of the following 5A to 5C:
5A) Cell search;
5B) Random access; and
5C) Data communication

The cell search is a procedure used for the terminal apparatus 1 synchronizing with a certain cell related to the time domain and the frequency domain and detecting a physical cell identity (physical cell ID). In other words, by means of the cell search, the terminal apparatus 1 may perform synchronization with a certain cell in the time domain and the frequency domain and detect a physical cell ID.

A sequence of the PSS is given based at least on the physical cell ID. A sequence of the SSS is given based at least on the physical cell ID.

An SS/PBCH block candidate indicates a resource allowed to (possible to, scheduled to, configured to, defined to, having a possibility to) transmit the SS/PBCH block.

A set of SS/PBCH block candidates in a certain half radio frame is also referred to as an SS burst set. The SS burst set is also referred to as a transmission window (transmissionwindow), an SS transmission window, or a Discovery Reference Signal transmission window (DRS transmission window). The SS burst set is a general term including at least a first SS burst set and a second SS burst set.

The base station apparatus 3 transmits SS/PBCH blocks with one or multiple indices at prescribed intervals. The terminal apparatus 1 may detect at least one SS/PBCH block out of the SS/PBCH blocks with one or multiple indices and attempt decoding of the PBCH included in the SS/PBCH block.

The random access is a procedure including at least some or all of a message 1, a message 2, a message 3, and a message 4.

The message 1 is a procedure in which the PRACH is transmitted by the terminal apparatus 1. The terminal apparatus 1 transmits the PRACH in one PRACH occasion selected out of one or multiple PRACH occasions based at least on the index of the SS/PBCH block candidate detected based on the cell search. Each of the PRACH occasions is defined based at least on resources in the time domain and the frequency domain.

The terminal apparatus 1 transmits one random access preamble selected out of the PRACH occasions corresponding to the indices of the SS/PBCH block candidates in which the SS/PBCH block is detected.

The message 2 is a procedure of attempting to detect a DCI format 1_0 with a Cyclic Redundancy Check (CRC) scrambled by a Random Access-Radio Network Temporary Identifier (RA-RNTI) by the terminal apparatus 1. The terminal apparatus 1 attempts detection of the PDCCH including the DCI format in a control resource set given based on the MIB, which is included in the PBCH included in the SS/PBCH block detected based on a cell search, and in resources indicated based on a configuration of a search space set. The message 2 is also referred to as a random access response.

The message 3 is a procedure of transmitting the PUSCH scheduled by using a random access response grant included in the DCI format 1_0 detected through the procedure of the message 2. Here, the random access response grant (random access responsegrant) is indicated by the MAC CE included in the PDSCH scheduled by using the DCI format 1_0.

The PUSCH scheduled based on the random access response grant is either a message 3 PUSCH or a PUSCH. The message 3 PUSCH includes a contention resolution identifier (contention resolution ID) MAC CE. The contention resolution ID MAC CE includes a contention resolution ID.

Retransmission of the message 3 PUSCH is scheduled by using a DCI format 0_0 with a CRC scrambled based on a Temporary Cell-Radio Network Temporary Identifier (TC-RNTI).

The message 4 is a procedure of attempting to detect the DCI format 1_0 with a CRC scrambled based on either of a Cell-Radio Network Temporary Identifier (C-RNTI) or a TC-RNTI. The terminal apparatus 1 receives a PDSCH scheduled based on the DCI format 1_0. The PDSCH may include a contention resolution ID.

Data communication is a general term for downlink communication and uplink communication.

In the data communication, the terminal apparatus 1 attempts detection of the PDCCH (monitors the PDCCH or supervises the PDCCH) in a control resource set and resources identified based on a search space set.

The control resource set is a set of resources including a certain number of resource blocks and a certain number of OFDM symbols. In the frequency domain, the control resource set may include continuous resources (non-interleaved mapping) or may include distributed resources (interleaver mapping).

A set of resource blocks constituting the control resource set may be indicated by a higher layer parameter. The number of OFDM symbols constituting the control resource set may be indicated by a higher layer parameter.

The terminal apparatus 1 attempts detection of the PDCCH in a search space set. Here, an attempt to detect the PDCCH in the search space set may be an attempt to detect a candidate of the PDCCH in the search space set, may be an attempt to detect a DCI format in the search space set, may be an attempt to detect the PDCCH in the control resource set, may be an attempt to detect a candidate of the PDCCH in the control resource set, or may be an attempt to detect a DCI format in the control resource set.

The search space set is defined as a set of candidates of the PDCCH. The search space set may be a Common Search Space (CSS) set or may be a UE-specific Search Space (USS) set. The terminal apparatus 1 attempts detection of candidates of the PDCCH in some or all of a Type 0 PDCCH common search space set, a Type 0a PDCCH common search space set, a Type 1 PDCCH common search space set, a Type 2 PDCCH common search space set, a Type 3 PDCCH common search space set, and/or a UE-specific PDCCH search space set (UE-specific search space set).

The Type 0 PDCCH common search space set may be used as a common search space set having the index 0. The Type 0 PDCCH common search space set may be a common search space set having the index 0.

A CSS set is a general term for the Type 0 PDCCH common search space set, the Type 0a PDCCH common search space set, the Type 1 PDCCH common search space set, the Type 2 PDCCH common search space set, and the Type 3 PDCCH common search space set. A USS set is also referred to as a UE-specific PDCCH search space set.

A certain search space set is related to (included in or corresponds to) a certain control resource set. The index of the control resource set related to the search space set may be indicated by a higher layer parameter.

For a certain search space set, some or all of 6A to 6C may be indicated by at least a higher layer parameter:
6A) PDCCH monitoring periodicity
6B) PDCCH monitoring pattern within a slot
6C) PDCCH monitoring offset

The monitoring occasion of a certain search space set may correspond to the OFDM symbol to which the first OFDM symbol of a control resource set related to the certain search space set is mapped. The monitoring occasion of a certain search space set may correspond to a resource of a control resource set starting from the first OFDM symbol of the control resource set related to the certain search space set. The monitoring occasion of the search space set is given based at least on some or all of the monitoring periodicity of the PDCCH, the monitoring pattern of the PDCCH in a slot, and a monitoring offset of the PDCCH.

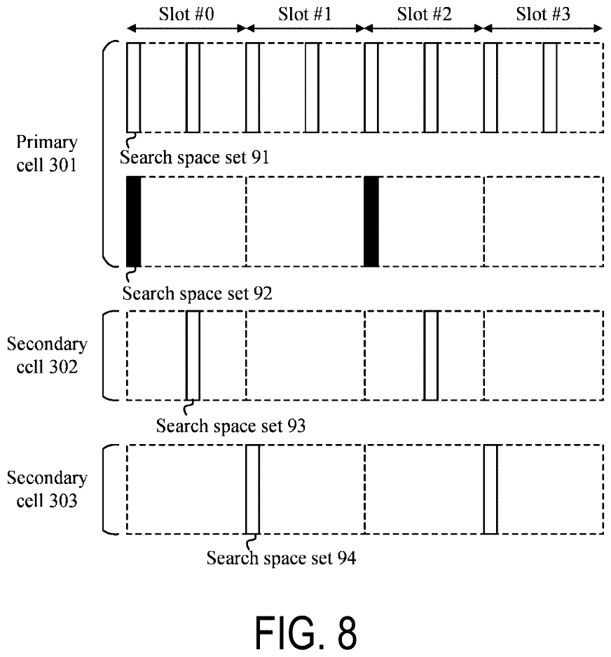

FIG. 8 is a diagram illustrating an example of the monitoring occasions for the search space sets according to an aspect of the present embodiment. In FIG. 8, search space sets 91 and search space sets 92 are configured in a primary cell 301, search space sets 93 are configured in a secondary cell 302, and search space sets 94 are configured in a secondary cell 303.

In FIG. 8, solid white blocks in the primary cell 301 represent the search space sets 91, solid black blocks in the primary cell 301 represent the search space sets 92, blocks in the secondary cell 302 represent the search space sets 93, and blocks in the secondary cell 303 represent the search space sets 94.

The monitoring periodicity of the search space sets 91 is set to one slot, the monitoring offset of the search space sets 91 is set to zero slots, and the monitoring pattern of the search space sets 91 is set to [1, 0, 0, 0, 0, 0, 0, 1, 0, 0, 0, 0, 0, 0]. In other words, the monitoring occasions for the search space sets 91 correspond to the first OFDM symbol (OFDM symbol #0) and the 8th OFDM symbol (OFDM symbol #7) in each of the slots.

The monitoring periodicity of the search space sets 92 is set to two slots, the monitoring offset of the search space sets 92 is set to zero slots, and the monitoring pattern of the search space sets 92 is set to [1, 0, 0, 0, 0, 0, 0, 0, 0, 0, 0, 0, 0, 0]. In other words, the monitoring occasion for the search space sets 92 corresponds to the first OFDM symbol (OFDM symbol #0) in each of the even-numbered slots.

The monitoring periodicity of the search space sets 93 is set to two slots, the monitoring offset of the search space sets 93 is set to zero slots, and the monitoring pattern of the search space sets 93 is set to [0, 0, 0, 0, 0, 0, 0, 1, 0, 0, 0, 0, 0, 0]. In other words, the monitoring occasion for the search space sets 93 corresponds to the 8th OFDM symbol (OFDM symbol #7) in each of the even-numbered slots.

The monitoring periodicity of the search space sets 94 is set to two slots, the monitoring offset of the search space sets 94 is set to one slot, and the monitoring pattern of the search space sets 94 is set to [1, 0, 0, 0, 0, 0, 0, 0, 0, 0, 0, 0, 0, 0]. In other words, the monitoring occasion for the search space sets 94 corresponds to the first OFDM symbol (OFDM symbol #0) in each of the odd-numbered slots.

The Type 0 PDCCH common search space set may be at least used for the DCI format with a Cyclic Redundancy Check (CRC) sequence scrambled by a System Information-Radio Network Temporary Identifier (SI-RNTI).

The Type 0a PDCCH common search space set may be at least used for the DCI format with a Cyclic Redundancy Check (CRC) sequence scrambled by a System Information-Radio Network Temporary Identifier (SI-RNTI).

The Type 1 PDCCH common search space set may be at least used for the DCI format with a CRC sequence scrambled by a Random Access-Radio Network Temporary Identifier (RA-RNTI) and/or a CRC sequence scrambled by a Temporary Cell-Radio Network Temporary Identifier (TC-RNTI).

The Type 2 PDCCH common search space set may be used for the DCI format with a CRC sequence scrambled by a Paging-Radio Network Temporary Identifier (P-RNTI).

The Type 3 PDCCH common search space set may be used for the DCI format with a CRC sequence scrambled by a Cell-Radio Network Temporary Identifier (C-RNTI).

The UE-specific PDCCH search space set may be at least used for the DCI format with a CRC sequence scrambled by C-RNTI.

In downlink communication, the terminal apparatus 1 detects a downlink DCI format. The detected downlink DCI format is at least used for resource assignment of the PDSCH. The detected downlink DCI format is also referred to as downlink assignment. The terminal apparatus 1 attempts reception of the PDSCH. A HARQ-ACK corresponding to the PDSCH (HARQ-ACK corresponding to the transport block included in the PDSCH) is reported to the base station apparatus 3 based on PUCCH resources indicated based on the detected downlink DCI format.

In uplink communication, the terminal apparatus 1 detects an uplink DCI format. The detected DCI format is at least used for resource assignment of the PUSCH. The detected uplink DCI format is also referred to as an uplink grant. The terminal apparatus 1 performs transmission of the PUSCH.

In configured scheduling (configured grant), the uplink grant for scheduling the PUSCH is configured for each transmission periodicity of the PUSCH. A part or all of pieces of information indicated by an uplink DCI format in a case that the PUSCH is scheduled by the uplink DCI format may be indicated by the uplink grant configured in a case of the configured scheduling.

A UL slot may be a slot including a UL symbol. A special slot may be a slot including a UL symbol, a flexible symbol, and a DL symbol. A DL slot may be a slot including a DL symbol.

The UL symbol may be an OFDM symbol configured or indicated for uplink in time division duplex. The UL symbol may be an OFDM symbol configured or indicated for the PUSCH, the PUCCH, the PRACH, or the SRS. The UL symbol may be provided by a higher layer parameter tdd-UL-DL-ConfigurationCommon. The UL symbol may be provided by a higher layer parameter tdd-UL-DL-ConfigurationDedicated. The UL slot may be provided by the higher layer parameter tdd-UL-DL-ConfigurationCommon. The UL slot may be provided by the higher layer parameter tdd-UL-DL-ConfigurationDedicated.

The DL symbol may be an OFDM symbol configured or indicated for downlink in time division duplex. The DL symbol may be an OFDM symbol configured or indicated for the PDSCH or the PDCCH. The DL symbol may be provided by the higher layer parameter tdd-UL-DL-ConfigurationCommon. The DL symbol may be provided by the higher layer parameter tdd-UL-DL-ConfigurationDedicated. The DL slot may be provided by the higher layer parameter tdd-UL-DL-ConfigurationCommon. The DL slot may be provided by the higher layer parameter tdd-UL-DL-ConfigurationDedicated.

The flexible symbol may be an OFDM symbol that is not configured or indicated as a UL symbol or a DL symbol among the OFDM symbols within a certain periodicity. The certain periodicity may be a periodicity given by a higher layer parameter dl-UL-TransmissionPeriodicity. The flexible symbol may be an OFDM symbol configured or indicated for the PDSCH, the PDCCH, the PUSCH, the PUCCH, or the PRACH.

The higher layer parameter tdd-UL-DL-ConfigurationCommon may be a parameter for configuring one of a UL slot, a DL slot, and a special slot for each of one or multiple slots. The higher layer parameter tdd-UL-DL-ConfigurationDedicated may be a parameter for configuring any one of a UL symbol, a DL symbol, and a flexible symbol for a flexible symbol in each of the one or multiple slots. tdd-UL-DL-ConfigurationCommon may be a common higher layer parameter. tdd-UL-DL-ConfigurationDedicated may be a dedicated higher layer parameter.

Multiple Transmission Reception Points (Transmit/Receive Points or TRPs) may be used. The base station apparatus 3 may include multiple TRPs (Multi-TRP). The terminal apparatus 1 may be scheduled by two TRPs in one serving cell. In Multi-TRP, the operation mode of one of single-DCI and multi-DCI may be used. In Multi-TRP, uplink control may be completed in the MAC layer and the physical layer. In Multi-TRP, downlink control may be completed in the MAC layer and the physical layer. In the Single-DCI mode, the terminal apparatus 1 may be scheduled by the same DCI for two TRPs. In a Multi-DCI mode, the terminal apparatus 1 may be scheduled by independent DCI from each TRP. Each TRP in the Multi-TRP may be identified by TRP information. That is, one TRP in the Multi-TRP may be identified by one piece of TRP information. The TRP information may be used to select one TRP.

A value of a Timing advance offset (TA offset) may be provided by a higher layer parameter. A Timing advance (TA) may be determined based at least on a TA offset. In one serving cell, one TA offset may be provided. In one serving cell, two TA offsets may be provided. In a case that no higher layer parameter is provided, the terminal apparatus 1 may determine the value of the TA offset. The terminal apparatus 1 may determine values of two TA offsets in one serving cell. The value of the TA offsets may be N_{TA, offset}. A higher layer parameter may be n-TimingAdvanceOffset. The determination of the TA may be adjustment of an uplink timing.

In a case that two uplink carriers are configured in one serving cell, the value of one TA offset may be applied to the two uplink carriers. In a case that two Transmission Reception Points (TRPs) are configured in one serving cell, a value of one TA offset may be applied to the two TRPs. In a case that two TRPs are configured in one serving cell, values of two TA offsets may be applied to the two TRPs, respectively.

The terminal apparatus 1 may adjust the uplink timing. For example, the terminal apparatus 1 may adjust the uplink timing in response to reception of a Timing advance command (TA command). For example, in response to the reception of one Timing advance command (TA command) for one Timing advance group (TAG), the terminal apparatus 1 may adjust the uplink timing for PUSCH/SRS/PUCCH transmission in all serving cells in one TAG. For example, in response to the reception of one TA command for one TAG, the terminal apparatus 1 may adjust the uplink timing for the PUSCH/SRS/PUCCH transmission in one or multiple serving cells belonging to one TAG. For example, the terminal apparatus 1 may adjust the uplink timing based on the value of N_{TA, offset}. N_{TA, offset} may be the same for all serving cells in one TAG. N_{TA, offset} need not be the same for all serving cells in one TAG. In addition, the terminal apparatus 1 may adjust the uplink timing based on one or both of the value of N_{TA, offset} and a TA command. The uplink timing may be the same for all serving cells in one TAG. The uplink timing need not be the same for all serving cells in one TAG. For example, a first uplink timing may be the same for a first portion of the serving cells in one TAG. For example, a second uplink timing may be the same for a second portion of the serving cells in one TAG. All serving cells in one TAG may be divided into the first portion and a second portion.

In response to the reception of one Timing advance command (TA command) for one subTAG, the terminal apparatus 1 may adjust the uplink timing for PUSCH/SRS/PUCCH transmission corresponding to one subTAG (or subTAG ID). For example, in response to the reception of one TA command for one subTAG, the terminal apparatus 1 may adjust the uplink timing for the PUSCH/SRS/PUCCH transmission in one or multiple serving cells belonging to one subTAG or TRPs. N_{TA, offset} may be the same for all serving cells in one subTAG. The uplink timing may be the same for all serving cells in one subTAG. In one serving cell, two subTAGs may be used.

The terminal apparatus 1 may determine the uplink timing based on at least some or all of a TA command, a TA offset, and TRP information. The first uplink timing and the second uplink timing may be determined based at least on the TRP information. For example, Transmission Reception Point (TRP) information may be information for identifying one TRP among one or multiple TRPs. For example, the TRP information may be an index for identifying one TRP. For example, one TRP may be determined based on the TRP information. For example, the TRP information may be information for identifying one or multiple TRPs. The TRP information may be provided by a higher layer parameter. The TRP information may be included in a random access response. The TRP information may be included in a DCI format. The TRP information may be a CORESET pool index. The TRP information may be associated with an index of the CORESET resource pool. For example, a first CORESET pool index may be associated with a first TRP and a second CORESET pool index may be associated with a second TRP. The TRP information may be associated with a pool (or pool index) of a TCI state. The first one or multiple TCI states may be associated with a pool index of the first TCI state. The second one or multiple TCI states may be associated with a pool index of the second TCI state. The TRP information may be a TAG ID (subTAG ID). For example, a first TAG ID (subTAG ID) may be associated with the first TRP, and a second TAG ID (subTAG ID) may be associated with the second TRP.

The first uplink timing may be determined based on a Timing adjustment indication for one TAG from an MCG. The second uplink timing may be determined based on a timing adjustment indication for one TAG from an SCG. The first and second uplink timings may be determined based on a timing adjustment indication for two TAGs from an MCG.

The TA command may be modified based on a subcarrier spacing. For example, in a subcarrier spacing configuration μ, one TA command for one TAG may indicate a change in an uplink timing. For example, the uplink timing may be changed by a multiple of 16*64*T_{c}/2^{μ}. “*” may be a multiplication operator.

A Timing advance (TA) of a random access preamble may be 0.

The TA command may be included in a random access response. For example, a TA command for one TAG (or subTAG) may be included in a random access response associated with one TAG (or subTAG). For example, a TA command associated with one piece of TRP information may be included in a random access response in a random access procedure associated with one piece of TRP information. The TA command may be transmitted as a MAC CE command. For example, the TA command may be an Absolute timing advance command MAC CE. The random access response or the TA command TA in case of an Absolute timing advance command MAC CE may indicate the value of N_{TA} for one TAG. For example, TA may be an integer from 0 to 3846. For example, N_{TA} may be TA*16*64/2^{μ}. N_{TA} may be associated with a subcarrier spacing of certain uplink transmission. For example, the certain uplink transmission may be uplink transmission from the terminal apparatus 1. For example, the certain uplink transmission may be first uplink transmission after receiving a random access response. For example, the certain uplink transmission may be the first uplink transmission after reception of an absolute timing advance command MAC CE. TA may be an index value. The uplink transmission may be uplink channel transmission.

The TA command T_{A} may indicate adjustment of the current N_{TA} value for one TAG. For example, the TA command T_{A} may indicate adjustment from N_{TA, old} to N_{TA, new}. N_{TA, new} may be N_{TA, old}+(T_{A}−31)*16*64/24. For example, TA may be an integer from 0 to 63.

In a case that the terminal apparatus has one or multiple active uplink BWPs, the TA command (TA command value) may be associated with the maximum subcarrier spacing of the one or multiple active uplink BWPs. The TA command may be a TA command in one TAG including uplink BWPs on two uplink carriers of one serving cell. For example, N_{TA, new} for one uplink BWP with the first subcarrier spacing may be rounded to match the timing advance (TA) granularity for one uplink BWP with the first subcarrier spacing. The rounding of the value may be rounding of the value. For example, N_{TA, new} may be rounded while maintaining Timing advance (TA) accuracy requirements.

Adjustment of N_{TA} to a positive value may indicate advancing of an uplink transmission timing (uplink timing) for one Timing advance group (TAG). Adjustment of N_{TA} to a negative value may indicate delaying of an uplink transmission timing for one TAG.

In a case that one TA command is received in a first slot n, adjustment of the uplink transmission timing may be applied from the beginning of the second slot. The first slot n may be an uplink slot. The uplink slot may be a slot corresponding to an uplink frame. The second slot may be n+k+1+2^{μ}*K_{offset}. That is, the second slot may be a slot after k+1+2^{μ}*K_{offset} slots from the first slot n. K_{offset} may be provided by a higher layer parameter. k may be ceil (N^{subframe, μ}ₛₗₒₜ·(N_{T, 1}+N_{T, 2}+N_{TA, max}+0.5)/T_{sf}). The unit of N_{T, 1} may be milliseconds. N_{T, 1} may be the unit period of milliseconds of N₁ symbols. The N₁ symbols may correspond to a PDSCH processing time. N_{T, 2} may be the unit period of milliseconds of N₂ symbols. The N₂ symbols may correspond to a PUSCH preparation time. N_{TA}, max may be a maximum timing advance (TA) value in the unit period of milliseconds. N_{TA}, max may be a maximum TA value that can be provided by a 12-bit TA command field. N^{subframe, μ}ₛₗₒₜ may be the number of slots in one subframe. T_{sf} may be one millisecond. T_{sf} may be the period of a subframe. K_{offset} may be K_{cell, offset}−K_{UE, offset}. K_{cell}, offset may be provided by a higher layer parameter. K_{UE, offset} may be provided by one MAC CE command. K_{cell}, offset may be 0. K_{UE, offset} may be 0. One or both of N₁ and N₂ may be determined in association with the minimum Subcarrier spacing (SCS). The minimum subcarrier spacing may be a minimum subcarrier spacing among subcarrier spacings of all configured downlink BWPs and all configured uplink BWPs. In a case of μ=0, N₁ may be 14. The slot n and N^{subframe, μ}ₛₗₒₜ may be determined in association with the minimum subcarrier spacing. N_{TA}, max may be determined in association with the minimum subcarrier spacing. The slot n may be the last slot among one or multiple slots that overlap with the slot for PDSCH reception. For PDSCH reception, it may be assumed that T_{TA}=0. One TA command may be received on the PDSCH. A PDSCH including one TA command may be received. The PDSCH may provide one TA command.

In a case that the terminal apparatus 1 changes the active uplink BWP, the terminal apparatus 1 may determine the TA command (the TA command value) based on the subcarrier spacing of the changed active uplink BWP. For example, in a case that the terminal apparatus 1 changes the active uplink BWP in the period from the time the TA command is received to the time the adjustment for the uplink transmission timing is applied, the terminal apparatus 1 may determine the TA command based on the subcarrier spacing of the new active uplink BWP. In a case that the active uplink BWP is changed after the adjustment for the uplink transmission timing is applied, the terminal apparatus 1 may assume the same absolute timing advance command value (absolute timing advance command MAC CE). That is, the first absolute timing advance command value before the active uplink BWP is changed may be the same as the second absolute timing advance command value after the active uplink BWP is changed.

In a case that the downlink timing is changed and in a case that the downlink timing is not corrected, the terminal apparatus 1 may change N_{TA}. In a case that the downlink timing is changed and in a case that the downlink timing is partially corrected by the uplink timing adjustment without the TA command, the terminal apparatus 1 may change N_{TA}. The uplink timing adjustment may be determination or change of the uplink timing.

In a case that two adjacent slots are overlapped by one TA command, the latter slot may be reduced.

A timing advance group (TAG) may be a group of one or multiple serving cells. One or multiple serving cells may be configured by RRC. The one or multiple serving cells may use one TA value. The one or multiple serving cells may use one timing reference cell. A primary TAG (PTAG) may be a TAG including an SpCell. A secondary TAG (STAG) may be a TAG not including an SpCell. The one or multiple serving cells may use two TA values.

A subTAG may be one serving cell or a group of multiple serving cells. A subTAG may be a group of serving cells using the same TA (TA value). For example, a subTAG may be associated with one piece of TRP information. For example, a subTAG may be associated with one TRP. A serving cell associated with a subTAG need not be associated with a TAG. For example, a subTAG may be configured for one serving cell. For example, a serving cell associated with a subTAG may be associated with a TAG. A subTAG may be a group of one or multiple TRPs. A subTAG may be a group of TRPs using the same TA (TA value). For example, a subTAG may be associated with one serving cell. A subTAG may be A TA group for one serving cell. In one serving cell, two subTAGs may be provided, configured, or determined. In each sub TAG, a subTAG ID may be determined. A subTAG may be a type of TAG. That is, a TAG and a subTAG may be referred to as a TAG.

The RRC layer may configure one or multiple higher layer parameters for maintenance of uplink time alignment. For example, the RRC layer may configure a time alignment timer. For example, the time alignment timer may be configured by a higher layer parameter timeAlignmentTimer. The time alignment timer may control a first time. The first time may be a time at which a MAC entity regards multiple serving cells as belonging to an associated TAG. For example, the time alignment timer may be a time for uplink time alignment. That is, the fact that the time alignment timer is operating may mean that time alignment has been achieved. The time alignment may mean that an uplink timing is determined (or adjusted). That is, TA may be time alignment.

The RRC layer may configure one or multiple higher layer parameters for maintenance of multiple times of uplink time alignment. For example, the RRC layer may configure multiple time alignment timers. At least one of the multiple time alignment timers may be associated with a subTAG. At least one of the multiple time alignment timers may be associated with a TAG.

The time alignment timers may correspond to one subTAG. For example, the time alignment timer may control the time at which the MAC entity regards one or multiple serving cells as belonging to the subTAG. For example, the time alignment timer may control the time at which the MAC entity regards one or multiple TRPs as belonging to the subTAG.

The MAC entity may perform some or all of the first to fourth processing operations.

In the first processing, in a case that a Timing advance command MAC CE (TA command MAC CE) is received and N_{TA} is carried in the indicated TAG, the MAC entity may apply the TA command for the indicated TAG. In the first processing, in a case that a Timing advance command MAC CE (TA command MAC CE) is received and N_{TA} is carried in the indicated TAG, the MAC entity may start or restart the time alignment timer associated with the indicated TA command. The time alignment timer may be timeAlignmentTimer.

The second processing may be processing performed in a case that the TA command is received in a random access response (random access response message). The second processing may be processing in a case that a TA command is received in a message B (MSGB). The second processing may be processing in one serving cell belonging to one TAG (or subTAG). The second processing may be processing in the SpCell. In the second processing, in a case that a Random access preamble is not selected from preambles in a Contention-based random access (CBRA), the MAC entity may apply a TA command for one TAG (or subTAG) or may start or restart a time alignment timer associated with one TAG (or subTAG). The TA command may be received in a random access response.

In the second processing, in a case that the time alignment timer associated with one TAG (or subTAG) is not running, the MAC entity may apply the TA command for one TAG (or subTAG) and may start the time alignment timer. Furthermore, in a case that Contention resolution is not successfully completed, the MAC entity may stop the time alignment timer.

In the second processing, in a case that the time alignment timer associated with one subTAG is not running, the MAC entity may apply a TA command in a random access response in a first random access procedure, and may start the time alignment timer. Furthermore, in a case that contention resolution is not successfully completed, the MAC entity may stop the time alignment timer. The first random access procedure may be a random access procedure associated with one subTAG. The first random access procedure may be a random access procedure for TA acquisition.

In the second processing, in a case that the random access preamble is selected from the preamble in the CBRA and in a case that the time alignment timer associated with one TAG (or subTAG) is running, the MAC entity may ignore the received TA command.

In the third processing, in a case that an Absolute Timing Advance (TA) Command is received for a message A (MSGA) transmission including a C-RNTI MAC CE, the MAC entity may apply the absolute TA Command for a Primary TAG (PTAG) and may start or restart a time alignment timer associated with the PTAG.

In the third processing, in a case that an Absolute Timing Advance (TA) Command associated with one subTAG is received in response to a message A (MSGA) transmission including a C-RNTI MAC CE, the MAC entity may apply the absolute TA Command for one subTAG and may start or restart the time alignment timer associated with one subTAG.

The fourth processing may be processing in a case that the time alignment timer expires. In the fourth processing, in a case that the time alignment timer is associated with the PTAG (or the subTAG associated with the first TRP), the MAC entity may perform some or all of the first sub-operation to the seventh sub-operation. The first sub-operation may be to flush all HARQ buffers for all serving cells. The second sub-operation may be to notify the RRC of release of PUCCHs for all serving cells. The third sub-operation may be to notify the RRC of release of SRSs for all serving cells. The fourth sub-operation may be to clear the configured downlink assignment and the configured uplink grant. The fifth sub-operation may be to clear a PUSCH resource for semi-persistent CSI reporting. The sixth sub-operation may be to regard all time alignment timers being expired. The seventh sub-operation may be to maintain N_{TA} for all TAGS (or subTAGs). That is, in a case that the time alignment timer is not running, the MAC entity need not change N_{TA}. In the fourth processing, in a case that the time alignment timer is associated with a STAG (or the subTAG associated with the second TRP), the MAC entity may perform some or all of the 8th sub-operation to the 13th sub-operation. The 8th sub-operation may be to flush all HARQ buffers for the serving cell belonging to this TAG (or this subTAG). The 9th sub-operation may be to notify the RRC of release of PUCCHs for the serving cell belonging to the TAG (or the subTAG). The 10th sub-operation may be to notify the RRC of release of SRSs for the serving cell belonging to the TAG (or the subTAG). The 11th sub-operation may be to clear configured downlink assignment and a configured uplink grant for the serving cell belonging to the TAG (or the subTAG). The 12th sub-operation may be to clear a PUSCH resource for a semi-persistent CSI report for the serving cell belonging to the TAG (or the subTAG). The 13th sub-operation may be to maintain N_{TA} of the TAG (or the subTAG).

A HARQ buffer may store a MAC PDU to be transmitted. One HARQ buffer may be associated with one HARQ process. One HARQ process may correspond to one HARQ process ID. To flush a HARQ buffer may be to empty a HARQ buffer. In a case that a HARQ entity requests new transmission for one transport block, the HARQ process may store the MAC PDU in the associated HARQ buffer.

In a case that the MAC entity stops uplink transmission for the SCell to exceed the Maximum uplink transmission timing difference, the MAC entity may regard that stop of the time alignment timer as being expired. The time alignment timer may be a time alignment timer associated with the SCell.

In a case that the time alignment timer expires, the MAC entity need not perform uplink transmission. In a case that the time alignment timer is not running, the MAC entity need not perform uplink transmission. The uplink transmission need not include random access preamble transmission. The uplink transmission need not include message A transmission. The uplink transmission may be uplink transmission in one serving cell. The uplink transmission may be uplink transmission in one TRP. This time alignment timer may be a time alignment timer associated with a TAG to which one serving cell belongs. This time alignment timer may be a time alignment timer associated with a subTAG to which one serving cell belongs. This time alignment timer may be a time alignment timer associated with a subTAG to which one TRP belongs.

In a case that the time alignment timer associated with one subTAG expires, the MAC entity need not perform uplink transmission for one or multiple TRPs included in the one subTAG. In a case that the time alignment timer associated with one subTAG expires, the MAC entity need not perform uplink transmission associated with the one subTAG. This uplink transmission need not include one or both of the random access preamble transmission and the message A transmission. For example, in a case that a time alignment timer associated with one piece of TRP information expires, the MAC entity need not perform uplink transmission associated with the one piece of TRP information.

In a case that the time alignment timer associated with the PTAG is not running, the MAC entity need not perform uplink transmission in any serving cell. This uplink transmission need not include random access preamble transmission in an SpCell. This uplink transmission need not include message A transmission in the SpCell.

A MAC Protocol Data Unit (PDU) may be a bit string arranged in 1 byte. The MAC PDU may be transport blocks. For example, the MAC PDU may include one or multiple MAC subPDUs. Each MAC subPDU may include one MAC subheader. Each MAC subPDU may include one MAC subheader and one MAC Service Data Unit (SDU). Each MAC subPDU may include one MAC subheader and one MAC Control Element (CE). Each MAC subPDU may include one MAC header and padding. The MAC SDU may be data from a higher layer. The MAC SDU may be data to a higher layer.

A TA command may be a MAC CE. In addition, the TA command may be included in the MAC CE. For example, the TA command may be included in a TA command MAC CE. The TA command MAC CE may include a TAG ID and a TA command. The TAG ID may indicate one or both of one TAG and one subTAG. A TAG including an SpCell may correspond to a TAG ID 0. The TAG ID may be indicated with 2 bits. The TAG ID may indicate one subTAG. The TAG ID may indicate one TRP. The TA command may indicate TA. TA may be an integer from 0 to 63. TA may be used for controlling an amount of timing adjustment. The timing adjustment may be applied by the MAC entity. The TA command may be indicated with 6 bits. The TA command MAC CE may be identified by a MAC subheader with a certain Logical channel ID (LCID). A certain LCID may be the LCID corresponding to the index 61.

A TA command may be included in an absolute Timing advance command MAC CE (absolute TA command MAC CE). The absolute TA command MAC CE may include a reserved bit and a TA command. The TA command may indicate an index value TA. TA may be used for controlling an amount of timing adjustment. The TA command may be indicated with 12 bits. Reserved bits may be four bits. The value 0 may be set for the reserved bit. The absolute TA command MAC CE may include at least a TAG ID. The TAG ID may indicate one subTAG. The TAG ID may indicate one TRP. The absolute TA command MAC CE may be identified by a MAC subheader with a certain eLCID. The certain eLCID may be an eLCID corresponding to the index 316.

The TA command may be included in a random access response. For example, the TA command may be included in the MAC payload of the random access response. For example, the TA command may indicate an index value TA. TA may be used for controlling an amount of timing adjustment. The size of a TA command field may be 12 bits. The random access response may include the TA command, an uplink grant, and a Temporary C-RNTI. The uplink grant may indicate resources to be used in uplink. The uplink grant field may be 27 bits. The Temporary C-RNTI may indicate a temporary ID used by the MAC entity during random access. The Temporary C-RNTI field may be 16 bits. The random access response may be a MAC RAR. For example, the random access response may be fallbackRAR. The TA command may be included in a message B (MSGB). For example, the TA command may be included in the MAC payload of message B. The TA command may be included in successRAR. In addition, the random access response may include TRP information. For example, the TA corresponding to one TRP identified by the TRP information may be indicated by the TA command included in the random access response.

Random access (or a random access procedure) may be initiated by a MAC entity. The random access may be initiated by a PDCCH order (or PDCCH). The random access may be initiated by RRC. Random access in the SCell may be initiated by a PDCCH order. In addition, random access may be triggered by the MAC entity. Random access may be triggered by a PDCCH order. Random access may be triggered by RRC.

For example, random access may be triggered (initiated) by a certain event. For example, a certain event may be Initial access from an RRC_IDLE state. For example, the certain event may be an RRC connection Re-establishment procedure. For example, the certain event may be arrival of uplink or downlink data in the RRC_CONNECTED state in a case that the uplink synchronization state is “non-synchronized”. For example, the certain event may be arrival of uplink data in the RRC_CONNECTED state in a case that there are no PUCCH resources. For example, the certain event may be a failure of a scheduling request. For example, the certain event may be a request by RRC in response to a handover. For example, the certain event may be RRC connection Resume. For example, the certain event may be establishing Time alignment. For example, the certain event may be establishing time alignment for an STAG. For example, the certain event may be establishing time alignment for a certain TRP. For example, the certain event may be requesting Other SI. For example, the certain event may be Beam failure recovery. For example, the certain event may be TA acquisition. For example, the certain event may be secondary TA acquisition. The certain event may Detecting a certain request may be for the purpose of the random access procedure.

The random access (random access type) may be a 4-step-random access (4-step-random access type). The random access (random access type) may be a 2-step-random access (2-step-random access type). The random access may support a Contention-based random access (CBRA). That is, the random access may be CBRA. The random access may support a Contention-free random access (CFRA). That is, the random access may be CFRA. For example, the random access may be CBRA of the 4-step-random access type. For example, the random access may be CFRA of the 4-step-random access type. For example, the random access may be CBRA of the 2-step-random access type. For example, the random access may be CFRA of the 2-step-random access.

In the CBRA of the 4-step-random access type, the terminal apparatus 1 may transmit a message 1 (random access preamble), receive a message 2 (random access response), transmit a message 3, and receive a message 4 (contention resolution). In the CBRA of the 2-step-random access type, the terminal apparatus 1 may transmit a message A (random access preamble and PUSCH payload) and receive a message B (the contention resolution). In the CFRA of the 4-step-random access type, the terminal apparatus 1 may receive assignment of a random access preamble, transmit the random access preamble, and receive a random access response. In the CFRA of the 2-step-random access type, the terminal apparatus 1 may receive assignment of a random access preamble and a PUSCH, transmit the random access preamble and the PUSCH, and receive a random access response.

In a case that no CFRA resources are configured, a Reference signal received power (RSRP) Threshold may be used to select one of the 2-step-random access type and the 4-step-random access type. In a case that CFRA resources of the 4-step-random access type are configured, the terminal apparatus 1 may perform random access of the 4-step-random access type. In a case that CFRA resources of the 2-step-random access type are configured, the terminal apparatus 1 may perform random access of the 2-step-random access type.

The message 1 may include one preamble in the PRACH. After transmission of the message 1, the terminal apparatus 1 may monitor one response (random access response) within a configured window. In the CFRA, a dedicated preamble may be assigned. In the CFRA, the terminal apparatus 1 may end the random access in response to the reception of the random access response. In the CBRA, the terminal apparatus 1 may transmit the message 3 in response to the reception of the random access response. For example, the terminal apparatus 1 may transmit the message 3 by using an uplink grant (random access response grant). In the CBRA, the terminal apparatus 1 may monitor the message 4 (contention resolution). In a case that contention resolution after the transmission of the message 3 is not successful, the terminal apparatus 1 may transmit the message 1.

The message A may include one preamble in the PRACH. In addition, the message A may also include a payload in the PUSCH. After transmission of the message A, the terminal apparatus 1 may monitor one response (random access response) within a configured window. In the CFRA, the dedicated preamble and PUSCH resources for the transmission of the message A may be assigned. In the CFRA, the terminal apparatus 1 may end the random access in response to the reception of one response. In the CBRA, in a case that the contention resolution is successful, the terminal apparatus 1 may end the random access. In a case that a fallback indication is received in the message B, the terminal apparatus 1 may transmit the message 3 based on the fallback indication and monitor the contention resolution. In a case that the contention resolution after the transmission of the message 3 is not successful, the terminal apparatus 1 may transmit the message A. In a case that the random access of the 2-step-random access type is not completed, the terminal apparatus 1 may be configured to be switched to the CBRA of the 4-step-random access type.

The random access procedure may be initiated (triggered) by a PDCCH order. The random access procedure may be initiated (triggered) by the MAC. The random access procedure may be initiated (triggered) by RRC. The random access procedure in the SCell may be initiated by a PDCCH order. The random access procedure in a cell associated with an additional PCI index may be initiated by a PDCCH order.

For a MAC entity, there may be only one random access that can proceed simultaneously. In a case that first random access is in progress and in a case that second random access is triggered, the terminal apparatus 1 may continue the first random access. In a case that first random access is in progress and in a case that second random access is triggered, the terminal apparatus 1 may initiate the second random access.

The RRC may configure some or all of the first to ninth higher layer parameters for the random access. A first set of PRACH Occasions for message 1 (random access preamble) transmission may be configured by the first higher layer parameter. The first set may be used for the message A PRACH. A second set of PRACH occasions for random access preamble transmission for the message A may be configured by the first higher layer parameter. That is, the first higher layer parameter may determine an available set of PRACH occasions for transmission of random access preamble transmission. The PRACH occasions may be referred to as RA occasions. The PRACH occasions may be referred to as RACH occasions.

Some or all of the first to ninth higher layer parameters may be referred to as an RACH configuration. The RACH configuration may be configured in a higher layer parameter SI-RequestConfig, a higher layer parameter ReconfigurationWithSync, a higher layer parameter BeamFailureRecoveryConfig, a higher layer parameter RACH-ConfigCommon, a higher layer parameter TwoTA-Config1-r18, and a higher layer parameter TwoTA-Config2-r18. The RACH configuration may be included in some or all of the higher layer parameter SI-RequestConfig, the higher layer parameter ReconfigurationWithSync, the higher layer parameter BeamFailureRecoveryConfig, the higher layer parameter RACH-ConfigCommon, the higher layer parameter TwoTA-Config1-r18, and the higher layer parameter TwoTA-Config2-r18. The RACH configuration may be RACH-ConfigGeneric.

The first higher layer parameter may be prach-ConfigurationIndex. The first higher layer parameter may be configured in a configuration for the secondary TA acquisition (one or both of the higher layer parameter twoTA-Config1-r18 and the higher layer parameter twoTA-Config2-r18). The secondary TA acquisition may mean that two TAs (TAG or subTAG) are determined, provided or configured in one serving cell.

Power for the random access preamble may be configured by the third higher layer parameter. For example, power for the first (first-transmitted) random access preamble may be configured by the third higher layer parameter.

A threshold for RSRP may be configured by the fourth higher layer parameter. For example, the threshold for RSRP is SS/PBCH block selection, or. It may be a threshold for RSRP for CSI-RS selection. For example, the threshold for RSRP may be a threshold for RSRP for selecting a signal from two uplink carriers. The two uplink carriers may be of Normal Uplink (NUL) and Supplementary Uplink (SUL).

The maximum number of transmission operations of one or both of the message 1 and message A may be configured by the fifth higher layer parameter. One or both of the message 1 and message A may change the transmission power for each transmission operation. For example, the power for one or both of the message 1 and message A may be changed based on the sixth higher layer parameter. The sixth higher layer parameter may be a power ramping factor.

The random access preamble may be configured by the seventh higher layer parameter. For example, the index of the random access preamble used in the PRACH occasions may be configured by the seventh higher layer parameter. The seventh higher layer parameter may indicate any value from 0 to 63. The seventh higher layer parameter may be ra-PreambleIndex.

The number of SS/PBCH blocks mapped to each PRACH occasion may be defined by the eighth higher layer parameter. In addition, the number of CBRA random access preambles mapped to each SS/PBCH block may be defined by the eighth higher layer parameter. The CBRA random access preamble may be a Contention-based Random Access Preamble.

Transmission of one or both of the message 1 and message A may use the random access preamble corresponding to group A or group B. The terminal apparatus 1, for example, may transmit the message A using a random access preamble group A. The terminal apparatus 1, for example, may transmit the message A using a random access preamble group B.

The ninth higher layer parameter may define a PRACH occasion associated with one SS/PBCH block (SSB). The MAC entity may transmit the random access preamble in the PRACH occasion. The ninth higher layer parameter may be ra-ssb-OccasionMaskIndex.

First to twelfth variables (UE variables) may be used for the random access procedure. The first variable may be PREAMBLE_INDEX. The second variable may be PREAMBLE_TRANSMISSION_COUNTER. The third variable may be PREAMBLE_POWER_RAMPING_COUNTER. The fourth variable may be PREAMBLE_POWER_RAMPING_STEP. The fifth variable may be PREAMBLE_RECEIVED_TARGET_POWER. The sixth variable may be PREAMBLE_BACKOFF. The seventh variable may be PCMAC. The eighth variable may be SCALING_FACTOR_BI. The ninth variable may be TEMPORARY_C-RNTI. The tenth variable may be RA_TYPE. The eleventh variable may be POWER_OFFSET_2STEP_RA. The twelfth variable may be MSGA_PREAMBLE_POWER_RAMPING_STEP.

RA_TYPE may be set to 4-stepRA. For example, in a case that a random access procedure is initiated by a PDCCH order, and in a case that a random access preamble index (ra-PreambleIndex) is provided by a PDCCH, and in a case that the random access preamble index is not 0b000000, RA_TYPE may be set to 4-stepRA. For example, in a case that a random access procedure is initiated for an SI request and in a case that a random access resource (RACH configuration) is provided by RRC for the SI request, RA_TYPE may be set to 4-stepRA. In a case that a random access procedure is initiated for beam failure recovery (or beam failure recovery for the SpCell), and in a case that a CFRA resource corresponding to a beam failure recovery request for a 4-step random access type is provided, RA_TYPE may be set to 4-stepRA. In a case that a random access procedure is initiated for reconfiguration with sync and in a case that a CFRA resource for a 4-step random access type is provided in a higher layer parameter rach-ConfigDedicated, RA_TYPE may be set to 4-stepRA. For example, in a case that a random access procedure is initiated for the secondary TA acquisition and in a case that a random access resource (e.g., CFRA resource) are provided for the secondary TA acquisition, RA_TYPE may be set to 4-stepRA. The random access resource may be one or both of a CFRA resource and a CBRA resource. The fact that the random access resource is provided may mean that an RACH configuration is configured. The secondary TA acquisition may mean that the second TA is (or two TAs are) acquired in one serving cell. In a case that RA_TYPE is set to 4-stepRA, random access of the 4-step random access type may be performed. In a case that RA_TYPE is set to 2-stepRA, random access of the 2-step random access type may be performed.

In the case that RA_TYPE is set to 4-StepRA, the MAC entity may perform any of first to sixth operations.

The first operation may be performed in a case that a random access procedure is initiated for the beam failure recovery. The first operation may be performed in a case that a timer for beam failure recovery (beamFailureRecoveryTimer) is running or is not configured. The first operation may be performed in a case that the contention-free random access resources (CFRA resources) for the beam failure recovery request are provided by the RRC. The beam failure recovery request may be associated with any one of the SSB and the CSI-RS. The first operation may be performed in a case that at minimum one SSB or at minimum one CSI-RS is available. The at minimum one SSB may be an SSB with a Reference Signal Received Power (RSRP) above a threshold. The at minimum one CSI-RS may be a CSI-RS with an RSRP above a threshold. In the first operation, the MAC entity may select a first SSB. The first SSB may be an SSB included in a first reference signal set. The first SSB may be an SSB with an RSRP above a certain threshold. In the first operation, the MAC entity may select a first CSI-RS. The first CSI-RS may be a CSI-RS included in the first reference signal set. The first CSI-RS may be a CSI-RS with an RSRP above a certain threshold. The first reference signal set may be configured by the candidateBeamRSList. In a case that the first SSB is selected, PREAMBLE_INDEX may be set to a first random access preamble index (ra-PreambleIndex). The first random access preamble index may be ra-PreambleIndex corresponding to an SSB selected from a random access preambles set for the beam failure recovery.

The second operation may be performed in a case that a random access preamble index (ra-PreambleIndex) is provided by a PDCCH (PDCCH order). The second operation may be performed in a case that the random access preamble index is not a 0b000000. In the second operation, the MAC entity may set PREAMBLE_INDEX to the random access preamble index. In the second operation, one SSB may be indicated (signaled) by a PDCCH.

The second operation may be performed in a case that a random access preamble index (ra-PreambleIndex) is provided by a PDCCH (PDCCH order). The second operation may be performed in a case that the random access preamble index is not a 0b000000. The second operation may be performed in a case that the PDCCH provides a first value. The second operation may be performed in a case that the first value is determined by the PDCCH. In the second operation, the MAC entity may set PREAMBLE_INDEX to a second random access preamble index. The second random access preamble index may be a random access preamble index for the secondary TA acquisition. The second random access preamble index may be ra-PreambleIndex corresponding to the indicated SSB from a random access preamble set for the secondary TA acquisition. The first value may identify one RACH configuration. The first value may identify one higher layer parameter including an RACH configuration. The first index may be an additional PCI index, a TAG ID, and TRP information.

The third operation may be performed. The third action may be performed in a case that a CFRA resource associated with an SSB is provided in rach-ConfigDedicated. The third operation may be performed in a case that at minimum one SSB is available. The at minimum one SSB may be an SSB with an RSRP above a certain threshold. In the third operation, the MAC entity may select one SSB. One SSB may be with an RSRP above a certain threshold. In the third operation, the PREAMBLE_INDEX may be set to ra-PreambleIndex corresponding to the selected SSB.

The fourth operation may be performed. The fourth operation may be performed in a case that the random access procedure for the SI request is initiated. The fourth operation may be performed in a case that the random access resource for the SI request is provided by RRC. In the fourth operation, in a case that at minimum one SSB is available, the MAC entity may select one SSB. The at minimum one SSB may be with an RSRP above a certain threshold. One SSB may be with an RSRP above a certain threshold. In the fourth operation, the MAC entity may select any SSB. In the fourth operation, one random access preamble corresponding to the selected SSB may be selected from the random access preambles determined according to a higher layer parameter ra-PreambleStartIndex. In the fourth operation, PREAMBLE_INDEX may be set to the selected random access preamble.

The fifth operation may be performed. The fifth operation may be performed for CBRA preamble selection. In the fifth operation, the MAC entity may select one SSB. One SSB may be with an RSRP above a certain threshold. In the fifth operation also, the MAC entity may select any SSB.

The sixth operation may be performed. The sixth operation may be performed in a case that the random access procedure for the secondary TA acquisition is initiated. The sixth operation may be performed in a case that the random access resource for the secondary TA acquisition is provided by RRC. In the sixth operation, the MAC entity may select one SSB. One SSB may be with an RSRP above a certain threshold. In the sixth operation, any SSB may be selected. In the sixth operation, a random access preamble index (ra-PreambleIndex) corresponding to the selected SSB may be set. The random access resource for the secondary TA acquisition may be determined in one or both of the higher layer parameter twoTA-Config1-r18 and the higher layer parameter twoTA-Config2-r18.

The random access preamble may be associated with a reference signal (one of an SSB and a CSI-RS). For example, the number of random access preambles per one reference signal may be determined by a higher layer parameter.

In a case that a random access procedure is initiated for the SI request and in a case that the first higher layer parameter is configured, the MAC entity may determine a first PRACH occasion. The first PRACH occasion may be associated with the selected SSB. The first PRACH occasion may be determined based on a first restriction. The first restriction may be given by the higher layer parameter ra-ssb-OccasionMaskIndex. The first PRACH occasion may be the next valid PRACH occasion. The first higher layer parameter may be one or both of ra-AssociationPeriodIndex and si-RequestPeriod.

In any of the first to sixth operations in the case that RA_TYPE is set to 4-StepRA, in a case that an SSB is selected, the MAC entity may determine a second PRACH occasion. The selected SSB may be allowed by the first restriction. The selected SSB may be indicated by a PDCCH (PDCCH order).

In any of the first to sixth operations in the case that RA_TYPE is set to 4-StepRA, in a case that a CSI-RS is selected and in a case that there is no CFRA resource associated with the selected CSI-RS, the MAC entity may determine a third PRACH occasion based on the SSB.

In any of the first to sixth operations in the case that RA_TYPE is set to 4-StepRA, in a case that a CSI-RS is selected, the MAC entity may determine a fourth PRACH occasion corresponding to the selected CSI-RS.

In a case that random access (random access procedure) is initiated in one serving cell, the MAC entity may flush a message 3 buffer, flush a message A buffer, select a carrier for performing random access, determine a random access type, and perform a random access resource selection procedure (Random Access Resource selection procedure).

The MAC entity may randomly select one PRACH occasion of multiple PRACH occasions.

The MAC entity may perform a transmission procedure of the random access preamble.

The MAC entity may determine power based on the counter for each random access type. The MAC entity may calculate RA-RNTI associated with a PRACH occasion in which the random access preamble is transmitted. The MAC entity may indicate to the physical layer to transmit the random access preamble by using the selected PRACH occasion. The RA-RNTI associated with the PRACH occasion may be calculated based on some or all of the index of the first OFDM symbol of the PRACH occasion, the index of the first slot of the PRACH occasion in one system frame, the index of the PRACH occasion in the frequency domain, and an uplink carrier on which the random access preamble is transmitted.

The MAC entity may start a first window from the end of the random access preamble transmission. The random access preamble may be a Contention-free Random Access Preamble (CFRA random access preamble). The random access preamble may be a Contention-based Random Access Preamble (CBRA random access preamble). The MAC entity may monitor the PDCCH for a random access response. For example, while the first window is running, the MAC entity may monitor the PDCCH. The PDCCH may be a PDCCH in an SpCell. A notification of reception of the PDCCH may be received from the physical layer. The PDCCH transmission may be addressed to the C-RNTI. In a case that the CFRA random access preamble is transmitted by the MAC entity, the MAC entity may regard that the random access has been successfully completed.

Valid downlink assignment may be received on the PDCCH corresponding to the RA-RNTI. Received transport blocks may be decoded. The random access response may include a certain MAC subPDU. The certain MAC subPDU may carry a random access preamble ID. The MAC entity may regard that the random access response has been successfully received based at least on the random access response including a certain MAC subPDU.

The MAC entity may regard that the random access response has been successfully received. The MAC entity may regard that the random access has been successfully completed, may indicate reception of acknowledgements (ACKs) to higher layers, and may apply a received TA command based at least on the random access response regarded to have been successfully received. For example, the MAC entity may process the value of a received UL grant. For example, the MAC entity may indicate the received UL grant to the physical layer.

In a case that the reception of the random access response is regarded as being successful and in a case that the random access preamble is transmitted in one serving cell, the MAC entity may apply (process) the TA command for one serving cell. The MAC entity may apply the TA command for the one serving cell based at least on the random access response regarded as having been successfully received and the random access preamble being transmitted in the one serving cell. The MAC entity may apply the TA command for one TRP based at least on the random access response regarded as having been successfully received. For example, in a case that the MAC PDU includes a TA command (for example, an absolute TA command MAC CE), the MAC entity may apply (process) the TA command. For example, the MAC PDU may be included in a transport block. For example, one or multiple MAC SDUs may be multiplexed into a transport block. For example, the one or multiple MAC SDUs may be demultiplexed from a transport block.

A beam failure recovery (BFR) procedure may be configured for the MAC entity by RRC. The configuration of the BFR procedure may include an RACH configuration. The configuration of the BFR procedure may be the higher layer parameter BeamFailureRecoveryConfig. The MAC entity may trigger the BFR based on a value of BFI_COUNTER. BFI_COUNTER may be a counter for a beam failure candidate indication (Beam Failure Instance Indication). In a case that the BFR is triggered, the first random access procedure may be initiated. The first random access procedure may be a random access procedure for the beam failure recovery.

The terminal apparatus 1 may receive the higher layer parameter. The terminal apparatus 1 may initiate the random access procedure in response to reception of a higher layer parameter RRCReconfiguration. For example, in a case that the higher layer parameter RRCReconfiguration is received in a higher layer parameter nr-SCG and in a case that the higher layer parameter nr-SCG includes the higher layer parameter reconfigurationWithSync, the terminal apparatus 1 may initiate a second random access procedure in RRC. The RRCReconfiguration may be received for NR SCG RRC Reconfiguration. The second random access procedure may be a random access procedure for reconfiguration with synchronization (Reconfiguration with sync).

A secondary TA acquisition procedure may be configured for the MAC entity by RRC. A configuration of the secondary TA acquisition procedure may include an RACH configuration. The configuration of the secondary TA acquisition procedure may be one or both of TwoTA-Config1-r18 and TwoTA-Config2-r18. The MAC entity may trigger the secondary TA acquisition. For example, the MAC entity may trigger the secondary TA acquisition based on expiration of a timer associated with a subTAG. For example, up to two subTAGs may be provided in one serving cell. The secondary TA acquisition may be triggered to configure two TAs (TAGs) in one serving cell. Based on the secondary TA acquisition being triggered, a third random access procedure may be initiated. The third random access procedure may be a random access procedure for the secondary TA acquisition. The random access procedure for the secondary TA acquisition may be initiated in MAC or RRC in a case that one or both of TwoTA-Config1-r18 and TwoTA-Config2-r18 are provided.

Prior to the initiation of random access (a physical random access procedure), the physical layer may receive a set of SS/PBCH block indices from a higher layer and may provide a set of RSRP measurement to a higher layer. Before the initiation of the random access, the physical layer may indicate to a higher layer to perform type-1-random access. Before the initiation of the random access, the physical layer may indicate to a higher layer to perform type-2-random access. The type-1-random access may be random access of the 4-step-random access type. The type-2-random access may be random access of the 2-step-random access type. Before the initiation of the random access, the physical layer may receive one or multiple parameters from a higher layer. The one or multiple parameters may include a configuration of PRACH transmission parameters. The configuration of the PRACH transmission parameter may be an RACH configuration. The PRACH transmission parameter may be a PRACH preamble format for PRACH transmission, may be time resources, or may be frequency resources. The one or multiple parameters may include a parameter for determining a root sequence. The one or multiple parameters may include a parameter for determining a cyclic shift in a PRACH preamble sequence (a sequence of random access preambles). The one or multiple parameters may include TRP information. For example, one random access preamble may be associated with one TRP.

The random access may include at least transmission of the message 1 on the PRACH and the message 2. The random access may include transmission of the message 1 on the PRACH, the message 2, transmission of the PUSCH scheduled by a random access response grant (Random access response uplink grant), and the PDSCH for contention resolution. The message 1 may be a random access preamble. The message 2 may be a random access response message (random access response). For example, the message 2 may be a random access response accompanied with a PDCCH/PDSCH. The random access procedure may be referred to as random access.

The random access may include at least transmission of the message A and reception of the message B. The random access may include transmission of the message A, reception of the message B, transmission of the PUSCH scheduled by a random access response grant, and the PDSCH for contention resolution. The message A may be the random access preamble in the PRACH and the PUSCH. The message B may be a random access response. For example, the message B may be a random access response accompanied with a PDCCH/PDSCH. The random access response grant may be a fallback random access response grant.

In a case that random access is initiated by a PDCCH order, PRACH transmission (random access preamble transmission) may have the same subcarrier spacing as that of the PRACH transmission initiated by a higher layer. In a case that two uplink carriers are configured in one serving cell and in a case that the terminal apparatus 1 detects the PDCCH order, the terminal apparatus 1 may use the value of the UL/SUL indicator field from the detected PDCCH order in order to determine one uplink carrier for the PRACH transmission. In a case that N TRPs are configured in one serving cell and in a case that the terminal apparatus 1 detects the PDCCH order, the terminal apparatus 1 may use one field (or a value of the field) of the detected PDCCH order in order to determine one TRP for the PRACH transmission. In the random access procedure for the secondary TA acquisition, one field of the PDCCH order may include an additional PCI index.

Random access may be triggered by a higher layer or PDCCH order in response to a request for PRACH transmission. The configuration by the higher layer for the PRACH transmission may include some or all of the configuration for the PRACH transmission, the preamble index (index of the random access preamble), the preamble SCS (subcarrier spacing of the random access preamble), the RA-RNTI, the PRACH resource, and the TRP information.

The random access preamble may be a contention-based preamble. The random access preamble may be a contention-free preamble. The number of contention-based preambles for each valid PRACH occasion and each SS/PBCH block index may be configured by a higher layer parameter. The PRACH occasion may be valid. For example, the PRACH occasion may be valid based at least on an OFDM symbol configured for time division duplexing.

The terminal apparatus 1 may attempt to decode the DCI format 1_0 accompanied with CRC scrambled with a RA-RNTI. For example, in response to the PRACH transmission, the terminal apparatus 1 may attempt to decode the DCI format 1_0 accompanied by CRC scrambled with a RA-RNTI in a certain window. The certain window may be started based at least on the first OFDM symbol of a CORESET.

The terminal apparatus 1 may pass a transport block to the higher layer based at least on the fact that the terminal apparatus 1 detects the DCI format 1_0 accompanied by CRC scrambled with the RA-RNTI and the fact that the terminal apparatus 1 receives the transport block. For example, the transport may be received in the PDSCH within a certain window. The higher layer may analyze (parse) a transport block corresponding to a Random access preamble identity (RAPID) associated with the PRACH transmission. In a case that the higher layer identifies a RAPID in a random access response (random access response message), the higher layer may indicate an uplink grant (random access response grant) to the physical layer. The random access response may be a random access response of a transport block. The random access response grant may be a random access response uplink grant.

In a case that the terminal apparatus 1 does not detect the DCI format 1_0 accompanied by CRC scrambled with the RA-RNTI in the window or in a case that the terminal apparatus 1 does not receive the transport block in the PDSCH in the window, the higher layer may indicate the physical layer to transmit the PRACH. In addition, in a case that the higher layer does not identify the RAPID associated with the PRACH transmission, the higher layer may indicate the physical layer to transmit the PRACH. For example, the terminal apparatus 1 may be expected to transmit the PRACH at a prescribed time after the last OFDM symbol of the window. In addition, the terminal apparatus 1 may be expected to transmit the PRACH at a prescribed time after the last OFDM symbol of PDSCH reception. Transmission of the PRACH may mean transmission of a random access preamble.

The PDCCH order may trigger a Contention-free random access procedure (CFRA). For example, the PDCCH order may trigger a CFRA in one SpCell. The PDCCH order may initiate PRACH transmission. In a case that the terminal apparatus 1 attempts to detect the DCI format 1_0 accompanied by CRC scrambled with the RA-RNTI in response to the PRACH transmission initiated by the PDCCH order, it may be assumed that the PDCCH including the DCI format 1_0 and the PDCCH have the QCL characteristics in the same DMRS antenna port. The QCL properties may be large scale properties of a channel.

The random access response grant may be composed of one or multiple fields. For example, the one or multiple fields may include a frequency hopping flag field. For example, the one or multiple fields may include a frequency domain resource assignment field (or a PUSCH frequency resource assignment field). For example, the one or multiple fields may include a time domain resource assignment field (or a PUSCH time resource assignment field). For example, the one or multiple fields may include a Transmission power control (TPC) command field. For example, the one or multiple fields may include a CSI request field. For example, the one or multiple fields may include a field with TRP information.

In a case that a CRC of the DCI format 1_0 is scrambled by the C-RNTI and in a case that all of the frequency domain resource assignment fields are “1”, the DCI format 1_0 may be used for the first random access procedure. The first random access procedure may be referred to as a PDCCH order-initiated random access procedure. That is, the PDCCH in which the DCI format 1_0 is mapped may be in a PDCCH order.

The DCI format in the PDCCH order may include a random access preamble index field. The random access preamble index may be ra-PreambleIndex. The DCI format in the PDCCH order may include a UL/SUL indicator field. The UL/SUL indicator field may indicate a UL carrier. The DCI format in the PDCCH order may include an SS/PBCH index field. The SS/PBCH index field may indicate one SS/PBCH. One SS/PBCH may be used to determine an RACH occasion (PRACH occasion) for PRACH transmission. In a case that all of the random access preamble index values are not “0”, the SS/PBCH index field may indicate one SS/PBCH. The DCI format in the PDCCH order may include a PRACH mask index field. The PRACH mask index field may indicate one RACH occasion. One RACH occasion may be associated with one SS/PBCH. in the case that all of the random access preamble index values are not “0”, the PRACH mask index field may indicate one RACH occasion. The DCI format in the PDCCH order may include an additional PCI index field. The additional PCI index field may indicate the first higher layer parameter including an RACH configuration. The additional PCI index field may indicate one additional PCI index. One additional PCI index may be associated with the first higher layer parameter including an RACH configuration. The first higher layer parameter may be twoTA-Config1-r18. The first higher layer parameter may be twoTA-Config2-r18.

The PCI (Physical Cell ID) may be referred to as a physical cell ID. The additional PCI may be a physical cell ID for a non-serving cell. The additional PCI index may be an index for identifying the additional PCI. The additional PCI index may be configured by the higher layer parameter. The additional PCI index may be indicated by a DCI field. The additional PCI index may be used to indicate a physical cell ID.

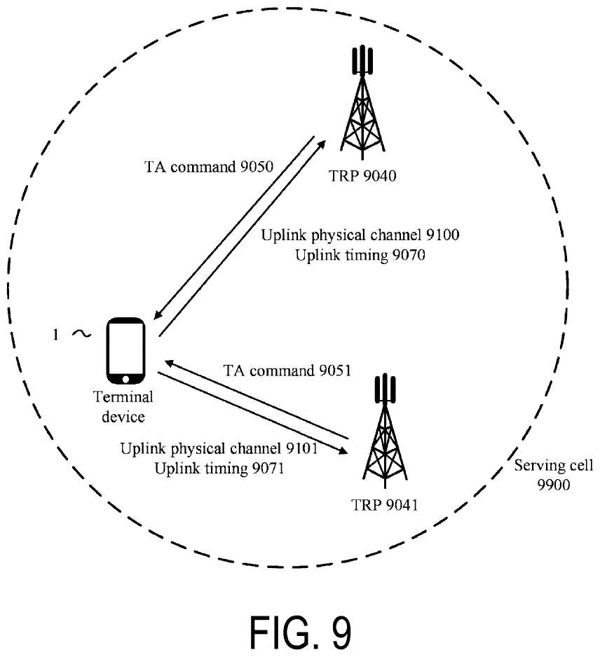

FIG. 9 is a diagram illustrating an example of the secondary TA acquisition according to an aspect of the present embodiment.

The terminal apparatus 1 may transmit a first random access preamble 9010 in a first random access 9000. The terminal apparatus 1 may receive a first random access response 9020 in the first random access 9000. The terminal apparatus 1 may transmit a second random access preamble 9011 in a second random access 9001. The terminal apparatus 1 may receive a second random access response 9021 in the second random access 9001. For example, in a case that the first random access 9000 is initiated (triggered), the terminal apparatus 1 may transmit the first random access preamble 9010 and may receive the first random access response 9020. In a case that the second random access 9001 is initiated (triggered), the terminal apparatus 1 may transmit the second random access preamble 9011 and may receive the second random access response 9021.

The terminal apparatus 1 may transmit the first random access preamble 9010 based at least on first TRP information 9030. For example, the first random access preamble 9010 may correspond to a first TRP 9040. The terminal apparatus 1 may receive the first random access response 9020 including the first TRP information 9030. The terminal apparatus 1 may transmit the second random access preamble 9011 based at least on second TRP information 9031. For example, the second random access preamble 9011 may correspond to a second TRP 9041. The terminal apparatus 1 may receive the second random access response 9020 including the second TRP information 9031. For example, the first higher layer parameter may indicate that the first random access preamble 9010 is transmitted to the first TRP 9040. For example, the second higher layer parameter may indicate that the second random access preamble 9011 is transmitted to the second TRP 9041. The first higher layer parameter may be the same as the second higher layer parameter.

The random access response may include a TA command. For example, the first random access response 9020 may include a first TA command 9050. For example, the second random access response 9021 may include a second TA command 9051. The first TA command 9050 may be different from the second TA command 9051. That is, the first TA command 9050 may be independent of the second TA command 9051. The terminal apparatus 1 may receive the first TA command 9050. The terminal apparatus 1 may receive the second TA command 9051.

A first TA 9060 may be determined based on the first TA command 9050. That is, a first uplink timing 9070 may be determined based on the first TA command 9050. The first uplink timing 9070 may be an uplink timing between the terminal apparatus 1 and the first TRP 9040. A second TA 9061 may be determined based on the second TA command 9051. That is, a second uplink timing 9071 may be determined based on the second TA command 9051. The second uplink timing 9071 may be an uplink timing between the terminal apparatus 1 and the second TRP 9041. The uplink timing may be a TA.

The first TA 9060 may correspond to a first subTAG 9200. The second TA 9061 may correspond to a second subTAG 9201. The first subTAG 9200 may correspond to a first TAG ID 9300. The second subTAG 9201 may correspond to a second TAG ID 9301.

The first TRP 9040 and the second TRP 9041 may be different TRPs. The first TRP 9040 and the second TRP 9041 may be configured by a higher layer parameter. The first TRP 9040 and the second TRP 9041 may be determined by a higher layer parameter. In a case that no higher layer parameter is configured, it may be assumed that there is not the second TRP 9041. The first TRP 9040 may be identified with a first ID (or index). The second TRP 9041 may be identified with a second ID (or index). The first ID and the second ID may be configured by a higher layer parameter. The first ID and the second ID may be included in a DCI format. The first ID and the second ID may be included in a random access response.

The base station apparatus 3 may be configured with the first TRP 9040 and the second TRP 9041. For example, the base station apparatus 3 may include two transmission and/or reception points (the base station apparatus 3a and the base station apparatus 3b). Furthermore, the first TRP 9040 may be a transmission and/or reception point of the base station apparatus 3a. The second TRP 9041 may be a transmission and/or reception point of the base station apparatus 3b. The base station apparatus 3a may have the functions of the base station apparatus 3 or may be independent of the base station apparatus 3b. The base station apparatus 3b may have the functions of the base station apparatus 3 or may be independent of the base station apparatus 3a. For example, the base station apparatus 3a need not be synchronized with the base station apparatus 3b. The TRP information may be used to select one of the base station apparatus 3a and the base station apparatus 3b.

The first TA command 9050 and the second TA command 9051 may be applied to one serving cell 9900. For example, the first TA command 9050 and the second TA command 9051 may simultaneously be applied to one serving cell 9900. For example, the first TA command 9050 and the second TA command 9051 may be received in one serving cell 9900. For example, the first TA command 9050 and the second TA command 9051 may be TA commands for one serving cell 9900. For example, the first TA command 9050 and the second TA command 9051 may be TA commands for one TAG. For example, the first TA command 9050 and the second TA command 9051 may be TA commands for one time alignment timer. That is, the first TA command 9050 and the second TA command 9051 may be TA commands for one time alignment timer associated with one TAG.

The first TA 9060 and the second TA 9061 may be applied to one serving cell 9900. For example, the first TA 9060 and the second TA 9061 may be received in one serving cell 9900. For example, the first TA 9060 and the second TA 9061 may be TAs for one serving cell 9900. That is, the terminal apparatus 1 may use the first TA 9060 and the second TA 9061 in one serving cell 9900. The first TA 9060 need not be updated (changed) based on the second TA command 9051. The second TA 9061 need not be updated (changed) based on the first TA command 9050.

The first uplink timing 9070 and the second uplink timing 9071 may be applied to one serving cell 9900. For example, the first uplink timing 9070 and the second uplink timing 9071 may be received in one serving cell 9900. For example, the first uplink timing 9070 and the second uplink timing 9071 may be uplink timings for one serving cell 9900. That is, the terminal apparatus 1 may use the first uplink timing 9070 and the second uplink timing 9071 in one serving cell 9900. The first uplink timing 9070 need not be updated (changed) based on the second TA command 9051. The second uplink timing 9071 need not be updated (changed) based on the first TA command 9050.

The terminal apparatus 1 may switch between the first uplink timing 9070 and the second uplink timing 9071. For example, the terminal apparatus 1 may use one of the first uplink timing 9070 and the second uplink timing 9071 for one uplink physical channel transmission in one serving cell 9900. For example, the terminal apparatus 1 may associate one of the first uplink timing 9070 and the second uplink timing 9071 with one uplink physical channel transmission based on the TRP information. For example, the terminal apparatus 1 may associate one of the first uplink timing 9070 and the second uplink timing 9071 with one uplink physical channel transmission based on a subTAG. For example, the terminal apparatus 1 may associate one of the first uplink timing 9070 and the second uplink timing 9071 with one uplink physical channel transmission based on an indication from a higher layer (for example, the MAC layer). For example, the terminal apparatus 1 may select one of the first uplink timing 9070 and the second uplink timing 9071. For example, the terminal apparatus 1 may select one of the first uplink timing 9070 and the second uplink timing 9071 based on certain information. The certain information may be one of the TRP information and the subTAG. The terminal apparatus 1 may receive certain information or a parameter including certain information. A parameter including certain information may be one of a higher layer parameter and a DCI format.

The switching between the first uplink timing 9070 and the second uplink timing 9071 may be switching between a first uplink frame 9080 and a second uplink frame 9081. This switching may be referred to as TA switching. This switching may be indicated by a DCI format. The TA switching may be triggered based on the uplink physical channel transmission being indicated. The TA switching may be performed taking a prescribed time 9090. For example, the TA switching may be completed after the prescribed time 9090 from a first time position. The first time position may be the last OFDM symbol of a PDCCH to which a DCI format indicating the TA switching is mapped. In a case that the TA switching switches the first uplink timing 9070 to the second uplink timing 9071, the first time position may be the last OFDM symbol of the latest uplink physical channel corresponding to the first uplink timing 9070. In the case that the TA switching switches the first uplink timing 9070 to the second uplink timing 9071, the first time position may be the last OFDM symbol of the PDCCH to which the DCI format is mapped that indicates the uplink physical channel transmission corresponding to the second uplink timing 9071 (scheduling the uplink physical channel). The prescribed time 9090 may be defined by any of the time unit, a real time (e.g., milliseconds, seconds), the number of OFDM symbols, and the number of slots. The prescribed time 9090 may be determined based on some or all of a maximum propagation delay difference, a maximum uplink transmission timing difference, a CP, a UE capability, a frequency range, and a higher layer parameter. For example, the prescribed time 9090 may be 14 OFDM symbols.

The terminal apparatus 1 may transmit a first uplink physical channel 9100 corresponding to the first uplink timing 9070 and a second uplink physical channel 9101 corresponding to the second uplink timing 9071 in one serving cell 9900. The first uplink physical channel 9100 may be the same as the second uplink physical channel 9101. For example, the transmission of the second uplink physical channel 9101 may be a repetition of the transmission of the first uplink physical channel 9100. That is, the terminal apparatus 1 may simultaneously transmit one uplink operation corresponding to the first uplink timing 9070 and the second uplink timing 9071 in one serving cell.

The first random access 9000 may be a CBRA and the second random access 9001 may be a CFRA. For example, the second random access 9001 may be initiated (triggered) by a PDCCH order. One of the first random access 9000 and the second random access 9001 may be a CFRA. One of the first random access 9000 and the second random access 9001 may be initiated by a PDCCH order. For example, in a case that the second random access 9001 is a CFRA, the second random access response 9021 may correspond to the first TRP 9040. For example, in a case that the second random access 9001 is a CFRA, the second random access preamble 9011 may correspond to the second TRP 9041 and the second random access response may correspond to the first TRP 9040. That is, the CFRA may be initiated to acquire the second TA 9061 (secondary TA acquisition). That is, a CSS set need not be configured for the second TRP 9041.

The corresponding to the first TRP 9040 may be corresponding to any one of the first TRP information 9030, the first TA 9060, the first uplink timing 9070, the first subTAG 9200, and the first TAG ID 9300. The corresponding to the second TRP 9041 may be corresponding to any one of the second TRP information 9031, the second TA 9061, the second uplink timing 9071, the second subTAG 9201, and the second TAG ID 9301.

The first random access 9000 may be a first CBRA and the second random access 9001 may be a second CBRA. The first random access 9000 and the second random access 9001 need not be simultaneously performed. For example, the first random access 9000 may be based on some or all of a first SS/PBCH block index, a first SS/PBCH block, and a first SS/PBCH candidate. The second random access 9001 may be based on some or all of a second SS/PBCH block index, a second SS/PBCH block, and a second SS/PBCH candidate.

The first random access preamble 9010 may be transmitted to the first TRP. The second random access preamble 9011 may be transmitted to the second TRP. For example, a higher layer parameter may indicate that the first random access preamble 9010 is transmitted to the first TRP 9040. For example, a higher layer parameter may indicate that the second random access preamble 9011 is transmitted to the second TRP 9041. For example, a PDCCH (e.g., PDCCH order) may indicate that the first random access preamble 9010 is transmitted to the first TRP 9040. For example, a PDCCH (e.g., PDCCH order) may indicate that the second random access preamble 9011 is transmitted to the second TRP 9041.

One or both of the first TA 9060 and the first uplink timing 9070 may be determined based at least on a first TA offset 9400 and the first TA command 9050. One or both of the second TA 9061 and the second uplink timing 9071 may be determined based at least on a second TA offset 9401 and the second TA command 9051. The first TA offset 9400 may be the same as the second TA offset 9401. The first TA offset 9400 and the second TA offset 9401 may be configured by, for example, one higher layer parameter. For example, in a case that one higher layer parameter is not provided, the terminal apparatus 1 may determine the first TA offset 9400 and the second TA offset 9401 as one value.

The first TA command 9050 may control an amount of first timing adjustment (first uplink timing adjustment). The second TA command 9051 may control an amount of second timing adjustment (second uplink timing adjustment). That is, the first TA command 9050 may indicate a first TA. The second TA command 9051 may indicate a second TA. The first TA and the second TA may be different.

In response to the reception of the first TA command 9050, the terminal apparatus 1 may adjust (determine) the first uplink timing 9070 for the transmission of the first uplink physical channel 9100. In response to the reception of the second TA command 9051, the terminal apparatus 1 may adjust (determine) the second uplink timing 9071 for the transmission of the second uplink physical channel 9101.

The RRC layer may configure a first time alignment timer 9800 and a second time alignment timer 9801. For example, the RRC layer may configure the first time alignment timer 9800 and the second time alignment timer 9801 for one serving cell 9900. For example, the first time alignment timer 9800 may be configured by the first higher layer parameter. For example, the second time alignment timer 9801 may be configured by the second higher layer parameter. The first higher layer parameter and the second higher layer parameter need not be the higher layer parameter timeAlignmentTimer. The first time alignment timer 9800 may control a first time. The first time may be a time at which the MAC entity regards that at least the first TRP 9040 belongs to the first subTAG 9200. The second time alignment timer 9801 may control a second time. The second time may be a time at which the MAC entity regards that at least the second TRP 9041 belongs to the second subTAG 9201.

The first time alignment timer 9800 may be started or restarted based at least on the first TA command 9050. The first time alignment timer 9800 may be associated with the first TRP 9040. The first time alignment timer 9800 may be associated with the first subTAG 9200. The first subTAG 9200 may identify the first TRP 9040 from one or multiple TRPs. The first subTAG 9200 may include the first TRP 9040. For example, the first subTAG 9200 may include one or multiple TRPs corresponding to the first TA 9060. The first time alignment timer 9800 may be associated with a third TAG 9502. That is, the first time alignment timer 9800 may be associated with the first subTAG 9200 and the third TAG 9502. A third time alignment timer 9802 may be associated with the third TAG 9502.

The second time alignment timer 9801 may be started or restarted based at least on the second TA command 9051. The second time alignment timer 9801 may be associated with the second TRP 9041. The second time alignment timer 9801 may be associated with the second subTAG 9201. The second subTAG 9201 may identify the second TRP 9041 from one or multiple TRPs. The second subTAG 9201 may include the second TRP 9041. For example, the second subTAG 9201 may include one or multiple TRPs corresponding to the second TA 9061. The second time alignment timer 9801 may be associated with the third TAG 9502. That is, the second time alignment timer 9801 may be associated with the second subTAG 9201 and the third TAG 9502. For example, the first subTAG 9200 and the second subTAG 9201 may correspond to one serving cell 9900.

The first time alignment timer 9800 may be different from the second time alignment timer 9801. That is, the first time alignment timer 9800 may be independent of the second time alignment timer 9801. For example, the first higher layer parameter for configuring the first time alignment timer 9800 may be independent of the second higher layer parameter for configuring the second time alignment timer 9801. The MAC entity may manage the first time alignment timer 9800 and the second time alignment timer 9801 in parallel.

The second TA command 9051 may be included in a TA command MAC CE or an absolute TA command MAC CE. For example, the TA command MAC CE or the absolute TA command MAC CE may include a field for identifying one of the second TRP 9041 and the second subTAG 9201. That is, the TA command MAC CE may include some or all of the TA command, the TAG ID, the ID for the second subTAG 9201, and the TRP information for the second TRP 9041. The absolute TA command MAC CE may include some or all of the TA command, the TAG ID, the ID for the second subTAG 9201, and the TRP information for the second TRP 9041.

In a case that the TA command MAC CE including the first TA command 9050 is received and a first N_{TA} is held in the first subTAG 9200, the MAC entity may apply the first TA command 9050. In the case that the TA command MAC CE including the first TA command 9050 is received and the first N_{TA} is held in the first subTAG 9200, the MAC entity may start or restart the first time alignment timer 9800 associated with the first TA command 9050.

In a case that the TA command MAC CE including the second TA command 9051 is received and a second N_{TA} is held in the second subTAG 9201, the MAC entity may apply the second TA command 9051. In the case that the TA command MAC CE including the second TA command 9051 is received and a second N_{TA} is held in the second subTAG 9201, the MAC entity may start or restart the second time alignment timer 9801 associated with the second TA command 9051. The MAC entity may manage some or all of the first time alignment timer 9800, the second time alignment timer 9801, and the third time alignment timer 9802.

In a case that the first time alignment timer 9800 is not running, the MAC entity may apply the first TA command 9050, and may start the first time alignment timer 9800. Furthermore, in a case that Contention resolution in first random access 9000 is not successfully completed, the MAC entity may stop the first time alignment timer 9800. In a case that the second time alignment timer 9801 is not running, the MAC entity may apply the second TA command 9051, and may start the second time alignment timer 9801. Furthermore, in a case that contention resolution in the second random access 9001 is not successfully completed, the MAC entity may stop the second time alignment timer 9801. The first time alignment timer 9800 and the second time alignment timer 9801 may be simultaneously running.

In a case that the first random access preamble 9010 is selected from the preambles in the CBRA, and in a case that the first time alignment timer 9800 is running, the MAC entity may ignore the first TA command 9050. In a case that the second random access preamble 9011 is selected from the preambles in the CBRA, and in a case that the second time alignment timer 9801 is running, the MAC entity may ignore the second TA command 9051.

The first time alignment timer 9800 and the second time alignment timer 9801 may correspond to one serving cell 9900. In a case that the first time alignment timer 9800 or the second time alignment timer 9801 expires, the MAC entity may flush all HARQ buffers for one serving cell 9900. In the case that the first time alignment timer 9800 or the second time alignment timer 9801 expires, the MAC entity may notify the RRC that the PUCCH for one serving cell 9900 is released. In the case that the first time alignment timer 9800 or the second time alignment timer 9801 expires, the MAC entity may notify the RRC that the SRS for one serving cell 9900 is released. In the case that the first time alignment timer 9800 or the second time alignment timer 9801 expires, the MAC entity may clear configured downlink assignment and the configured uplink grant. In the case that the first time alignment timer 9800 or the second time alignment timer 9801 expires, the MAC entity may clear the PUSCH resources for semi-persistent CSI reporting. In the case that the first time alignment timer 9800 or the second time alignment timer 9801 expires, the MAC entity may regard that all the time alignment timers corresponding to one serving cell 9900 expire. In the case that the first time alignment timer 9800 expires, the MAC entity may maintain the first N_{TA}. In the case that the second time alignment timer 9801 expires, the MAC entity may maintain the second N_{TA}.

In a case that the first time alignment timer 9800 is not running (expires), the MAC entity need not perform the first uplink transmission (the transmission of the first uplink physical channel 9100) for at least the first TRP 9040. In a case that the second time alignment timer 9801 is not running (expires), the MAC entity need not perform the second uplink transmission (the transmission of the second uplink physical channel 9101) for at least the second TRP 9041. The first uplink transmission and the second uplink transmission need not include one or both of the random access preamble transmission and the message A transmission.

In a case that reception of at least the first random access response 9020 is successfully completed, the MAC entity may apply (process) the first TA command 9050 for one serving cell 9900. The MAC entity may apply the first TA command 9050 for one or both of the one serving cell 9900 and the first TRP 9040 based at least on the reception of the first random access response 9020 being regarded successful and the first random access preamble 9010 being transmitted for the one serving cell 9900.

In order to improve the degree of freedom of a terminal position, reduce interference, expand the coverage, and the like, it is a problem that the terminal apparatus 1 determines an uplink timing for each of multiple transmission and/or reception points. This problem may be solved by the secondary TA acquisition. For example, means 1a, means 1b, means 1c, means 2a, and means 2b may be used for the secondary TA acquisition.

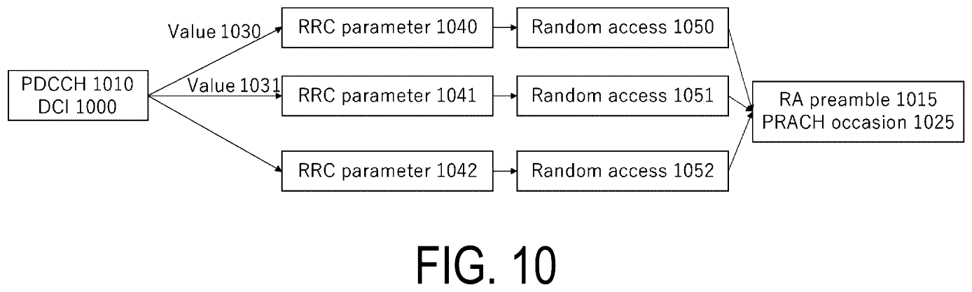

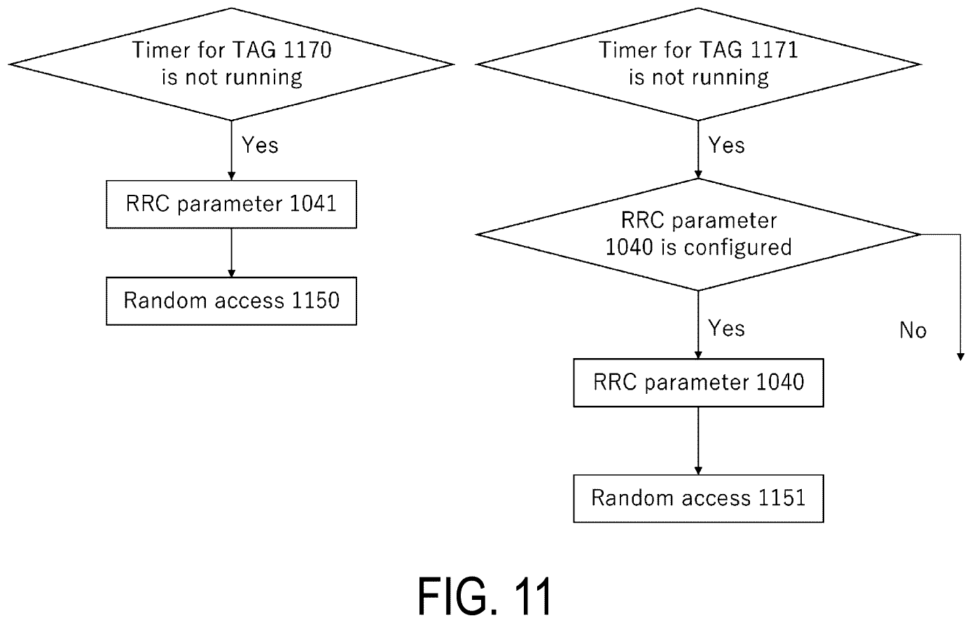

FIG. 10 is a diagram illustrating examples of means 1a, 1b, and 1c according to an aspect of the present embodiment. FIG. 11 is a diagram illustrating examples of means 2a and 2b according to an aspect of the present embodiment.

In means 1a, 1b, 1c, 2a, and 2b, the secondary TA acquisition may mean that one or both of the first TA 9060 and the second TA 9061 are determined in the serving cell 9900. The secondary TA acquisition may mean that one or both of the first random access procedure 9000 and the second random access procedure 9001 are performed in the serving cell 9900. The secondary TA acquisition may mean that one or both of the first random access preamble 9010 and the second random access preamble 9011 are transmitted in the serving cell 9900. The secondary TA acquisition may mean that one or both of the first random access response 9020 and the second random access response 9021 are received in the serving cell 9900. The secondary TA acquisition may mean that one or both of the first TRP information 9030 and the second TRP information 9031 are used in the serving cell 9900. The secondary TA acquisition may mean that one or both of the first TA command 9050 and the second TA command 9051 are received in the serving cell 9900. The secondary TA acquisition may mean that one or both of the first uplink timing 9070 and the second uplink timing 9071 are determined or adjusted in the serving cell 9900. The secondary TA acquisition may mean that one or both of the first uplink frame 9080 and the second uplink frame 9081 are determined in the serving cell 9900. The secondary TA acquisition may be performed for one or both of the first uplink physical channel 9100 and the second uplink physical channel 9101 in the serving cell 9900. The secondary TA acquisition may mean that one or both of the first subTAG 9200 and the second subTAG 9201 are determined in the serving cell 9900. The secondary TA acquisition may be performed based on one or both of the first TAG ID 9300 and the second TAG ID 9301 in the serving cell 9900. The secondary TA acquisition may be performed based on one or both of the first TAG 9500 and the second TAG 9501 in the serving cell 9900. The secondary TA acquisition may be performed in order for one or both of the first time alignment timer 9800 and the second time alignment timer 9801 to operate, start, or restart in the serving cell 9900.

In means 1a, 1b, and 1c, the terminal apparatus 1 may receive a PDCCH 1010. In means 1a, 1b, and 1c, the terminal apparatus 1 may receive the PDCCH 1010 to which DCI 1000 is mapped. For example, the DCI 1000 may be the DCI format 1_0. For example, the PDCCH 1010 may be a PDCCH order.

In means 1a, 1b, and 1c, the terminal apparatus 1 may transmit a random access preamble 1015. For example, in a random access procedure initiated (triggered) by the PDCCH 1010, the terminal apparatus 1 may transmit the random access preamble 1015. The random access procedure initiated by the PDCCH 1010 may be any one of random access procedures 1050, 1051, and 1052. The random access preamble 1015 may be transmitted in a PRACH occasion 1025.

In means 1a, 1b, 1c, 2a, and 2b, some or all of a first higher layer parameter 1040, a second higher layer parameter 1041, and a third higher layer parameter 1042 may include an RACH configuration.

In means 1a, 1b, 1c, 2a, and 2b, the first higher layer parameter 1040 may be two TA-Config1-r18. The second higher layer parameter 1041 may be twoTA-Config2-r18. The second higher layer parameter 1041 may be RACH-ConfigCommon. The third higher layer parameter 1042 may be RACH-ConfigCommon. The first higher layer parameter 1040 may be a dedicated higher layer parameter. The second higher layer parameter 1040 may be a dedicated higher layer parameter. The second higher layer parameter 1041 may be a common higher layer parameter. The third higher layer parameter 1042 may be a common higher layer parameter. The first higher layer parameter 1040 may correspond to one additional PCI index. The second higher layer parameter 1041 and the third higher layer parameter 1042 may be the same common higher layer parameters (e.g., RACH-ConfigCommon).

twoTA-Config1-r18 may correspond to one additional PCI index. twoTA-Config1-r18 may include one additional PCI index. That is, twoTA-Config1-r18 may correspond to any one of a first serving cell ID, a first physical cell ID, and a first set of SS/PBCH blocks. twoTA-Config1-r18 may be used in a case that one or multiple cells are configured. twoTA-Config2-r18 may correspond to any one of a second serving cell ID, a second physical cell ID, and a second set of SS/PBCH blocks. twoTA-Config2-r18 may be used in a case that one cell is configured.

twoTA-Config1-r18 may be associated with some or all of the first TAG information 9030, the first TRP 9040, the first TA 9060, the first uplink timing 9070, the first uplink frame 9080, the first subTAG 9200, the first TAG ID 9300, the first TAG 9500, and the serving cell 9900. twoTA-Config2-r18 may be associated with some or all of the second TAG information 9031, the second TRP 9041, the second TA 9061, the second uplink timing 9071, the second uplink frame 9081, the second subTAG 9201, the second TAG ID 9301, the second TAG 9501, and the serving cell 9900.

In means 1a, 1b and 1c, the random access procedure 1050 may be initiated based on the first higher layer parameters 1040. The random access procedure 1051 may be initiated based on the second higher layer parameter 1041. The random access procedure 1052 may be initiated based on the third higher layer parameter 1042. Some or all of the random access procedures 1050, 1051, and 1052 may be the random access procedure 9000. Some or all of the random access procedures 1050, 1051, and 1052 may be the random access procedure 9001. Some or all of the random access procedures 1050, 1051, and 1052 may be initiated for the secondary TA acquisition.

In means 1a, 1b and 1c, the PRACH occasion 1025 may be determined based on the first higher layer parameter 1040. The PRACH occasion 1025 may be determined based on the second higher layer parameter 1041. The PRACH occasion 1025 may be determined based on the third higher layer parameter 1042. The random access preamble 1015 may be determined based on the first higher layer parameters 1040. The random access preamble 1015 may be determined based on the second higher layer parameters 1041. The random access preamble 1015 may be determined based on the third higher layer parameters 1042.

In means 1a, the DCI 1000 may include a DCI field 1020. The DCI 1000 need not include the DCI field 1020. The DCI field 1020 may indicate one value. The DCI field 1020 may be set to one value. One value may be a first value 1030. One value may be a second value 1031. One value may be associated with one higher layer parameter. One higher layer parameter may include an RACH configuration. One higher layer parameter may be the first higher layer parameter 1040. One higher layer parameter may be the second higher layer parameter 1041. One higher layer parameter may be the third higher layer parameter 1042.

In means 1a, in a case that the DCI field 1020 indicates the first value 1030, the first higher layer parameter 1040 may be used. In a case that the DCI field 1020 indicates the second value 1031, the second higher layer parameter 1041 may be used. In a case that the DCI 1000 does not include the DCI field 1020, the third higher layer parameter 1042 may be used. In the case that the DCI field 1020 indicates the first value 1030, the random access procedure 1050 may be initiated based on the first higher layer parameter 1040. In the case that the DCI field 1020 indicates the second value 1031, the random access procedure 1051 may be initiated based on the second higher layer parameter 1041. In the case that the DCI 1000 does not include the DCI field 1020, the random access procedure 1052 may be initiated based on the third higher layer parameter 1042.

In means 1a, in the case that the DCI field 1020 indicates the first value 1030, the PRACH occasion 1025 may be determined based on the first higher layer parameter 1040. In the case that the DCI field 1020 indicates the second value 1031, the PRACH occasion 1025 may be determined based on the second higher layer parameter 1041. In the case that the DCI 1000 does not include the DCI field 1020, the PRACH occasion 1025 may be determined based on the third higher layer parameter 1042. In means 1a, in the case that the DCI field 1020 indicates the first value 1030, the random access preamble 1015 may be determined based on the first higher layer parameter 1040. In the case that the DCI field 1020 indicates the second value 1031, the random access preamble 1015 may be determined based on the second higher layer parameter 1041. In the case that the DCI 1000 does not include the DCI field 1020, the random access preamble 1015 may be determined based on the third higher layer parameter 1042.

In means 1a, one or both of the first value 1030 and the second value 1031 may be any one of one additional PCI index (AdditionalPCIIndex), one CORESET pool index (CORESETPoolIndex), the first TRP information 9030, the second TRP information 9031, the first TRP 9040, the second TRP 9041, the first subTAG 9200, the second subTAG 9201, the first TAG ID 9300, the second TAG ID 9301, the first TAG 9500, the second TAG 9501, the first time alignment timer 9800, and the second time alignment timer 9801.

In means 1a, whether the DCI 1000 includes the DCI field 1020 may be determined based on whether the first higher layer parameter 1040 or the second higher layer parameter 1041 is configured. For example, in a case that the first higher layer parameter 1040 is configured, the DCI 1000 may include the DCI field 1020. In a case that the first higher layer parameter 1040 is not configured, the DCI 1000 need not include the DCI field 1020. For example, in a case that the second higher layer parameter 1041 is configured, the DCI 1000 may include the DCI field 1020. In a case that the second higher layer parameter 1041 is not configured, the DCI 1000 need not include the DCI field 1020.

In means 1b, the DCI 1000 or the PDCCH 1000 may be associated with or correspond to one CORESET pool index. For example, one CORESET pool index may be the first value 1030. One CORESET pool index may be the second value 1031. The first value 1030 may be 1 and the second value 1031 may be 0. The first value 1030 may be 0 and the second value 1031 may be 1.

In means 1b, in a case that one CORESET pool index is the first value 1030, the first higher layer parameter 1040 may be used. In a case that one CORESET pool index is the second value 1031, the second higher layer parameter 1041 may be used. In a case that one or both of the first higher layer parameter 1040 and the second higher layer parameter 1041 are not configured, the third higher layer parameter 1042 may be used.

In means 1b, in the case that one CORESET pool index is the first value 1030, the random access procedure 1050 may be initiated based on the first higher layer parameter 1040. In the case that one CORESET pool index is the second value 1031, the random access procedure 1051 may be initiated based on the second higher layer parameter 1041. In the case that one or both of the first higher layer parameter 1040 and the second higher layer parameter 1041 are not configured, the random access procedure 1052 may be initiated based on the third higher layer parameter 1042.

In means 1b, in the case that one CORESET pool index is the first value 1030, the PRACH occasion 1025 may be determined based on the first higher layer parameter 1040. In the case that one CORESET pool index is the second value 1031, the PRACH occasion 1025 may be determined based on the second higher layer parameter 1041. In the case that one or both of the first higher layer parameter 1040 and the second higher layer parameter 1041 are not configured, the PRACH occasion 1025 may be determined based on the third higher layer parameter 1042. In means 1b, in the case that one CORESET pool index is the first value 1030, the random access preamble 1015 may be determined based on the first higher layer parameter 1040. In the case that one CORESET pool index is the second value 1031, the random access preamble 1015 may be determined based on the second higher layer parameter 1041. In the case that one or both of the first higher layer parameter 1040 and the second higher layer parameter 1041 are not configured, the random access preamble 1015 may be determined based on the third higher layer parameter 1042.

In means 1c, in the case that the first higher layer parameter 1040 is configured and in a case that the third higher layer parameter 1042 is configured, the first higher layer parameter 1040 may be used. In the case that the first higher layer parameter 1040 is not configured and in the case that the third higher layer parameter 1042 is configured, the third higher layer parameter 1042 may be used. In the case that the first higher layer parameter 1040 is configured and in the case that the third higher layer parameter 1042 is configured, the random access procedure 1050 may be initiated based on the first higher layer parameter 1040. In the case that the first higher layer parameter 1040 is not configured and in the case that the third higher layer parameter 1042 is configured, the random access procedure 1052 may be initiated based on the third higher layer parameter 1042. In the case that the first higher layer parameter 1040 is configured and in the case that the third higher layer parameter 1042 is configured, the PRACH occasion 1025 may be determined based on the first higher layer parameter 1040. In the case that the first higher layer parameter 1040 is not configured and in the case that the third higher layer parameter 1042 is configured, the PRACH occasion 1025 may be determined based on the third higher layer parameter 1042. In the case that the first higher layer parameter 1040 is configured and in the case that the third higher layer parameter 1042 is configured, the random access preamble 1015 may be determined based on the first higher layer parameter 1040. In the case that the first higher layer parameter 1040 is not configured and in the case that the third higher layer parameter 1042 is configured, the random access preamble 1015 may be determined based on the third higher layer parameter 1042.

In means 2a and 2b, the terminal apparatus 1 may transmit a random access preamble 1115. For example, the terminal apparatus 1 may transmit the random access preamble 1115 in a random access procedure 1150. For example, the terminal apparatus 1 may transmit the random access preamble 1115 in a random access procedure 1151. The terminal apparatus 1 may transmit the random access preamble 1115 in a PRACH occasion 1125. The terminal apparatus 1 may receive a random access response 1160. The terminal apparatus 1 may receive the random access response 1160 in the random access procedure 1150. The terminal apparatus 1 may receive the random access response 1160 in the random access procedure 1151. The random access preamble 1115 may be any one of the random access preamble 9010 and the random access preamble 9011. The random access response 1160 may be any one of the random access response 9020 and the random access response 9021. One or both of the random access preamble 1115 and the PRACH occasion 1125 may be associated with the random access procedure 1150 or the random access procedure 1151. One or both of the random access procedure 1150 and the random access procedure 1151 may be initiated for the secondary TA acquisition.

In means 2a and 2b, a first TAG 1170 may be any one of the subTAG 9200 and the TAG 9500. A second TAG 1171 may be any one of the subTAG 9201 and the TAG 9501. The first TAG 1170 may be associated with the TAG ID 9300. The second TAG 1171 may be associated with the TAG ID 9301. The first TAG 1170 may correspond to or be associated with the first time alignment timer 9800. The second TAG 1171 may correspond to or be associated with the second time alignment timer 9801. The first TAG 1170 may correspond to the first TRP information 9030. The second TAG 1171 may correspond to the second TPR information 9031.

In means 2a and 2b, the random access procedure 1150 may be initiated for the first TAG 1170. The random access procedure 1151 may be initiated for the second TAG 1171. In means 2a and 2b, the random access procedure 1150 and the random access procedure 1151 may be initiated in RRC or MAC.

In means 2a, the first TAG 1170 and the second TAG 1171 may correspond to the serving cell 9900. In means 2a, the first TAG 1170 and the second TAG 1171 may correspond to different serving cells. For example, in means 2a, the first TAG 1170 may be associated with an additional PCI.

In means 2b, the first TAG 1170 and the second TAG 1171 may correspond to the serving cell 9900.

In means 2a and 2b, the random access procedure 1150 may be initiated for the first TAG 1170. The random access procedure 1151 may be initiated for the second TAG 1171. For example, in a case that a time alignment timer associated with the first TAG 1170 expires (is not running), the random access procedure 1150 may be initiated. In a case that a time alignment timer associated with the second TAG 1171 expires (is not running), the random access procedure 1151 may be initiated.

In means 2a, in the case that the first higher layer parameter 1040 is configured and in the case that the time alignment timer associated with the first TAG 1170 expires, the random access procedure 1150 may be initiated based on the second higher layer parameter 1041. In the case that the first higher layer parameter 1040 is not configured and in the case that the time alignment timer associated with the first TAG 1170 expires, the random access procedure 1150 may be initiated based on the second higher layer parameter 1041.

In means 2a, in the case that the first higher layer parameter 1040 is configured and in the case that the time alignment timer associated with the second TAG 1171 expires, the random access procedure 1151 may be initiated based on the first higher layer parameter 1040. In the case that the first higher layer parameter 1040 is not configured and in the case that the time alignment timer associated with the second TAG 1171 expires, the random access procedure 1151 may be initiated based on the second higher layer parameter 1041. In the case that the first higher layer parameter 1040 is not configured and in the case that the time alignment timer associated with the second TAG 1171 expires, the random access procedure 1151 need not be initiated. In the case that the first higher layer parameter 1040 is not configured and in the case that the time alignment timer associated with the second TAG 1171 expires, the random access procedure 1151 need not be expected to be initiated.

In means 2a, the second higher layer parameter 1041 may be RACH-ConfigCommon or twoTA-Config2-r18. twoTA-Config2-r18 may provide a CFRA resource. RACH-ConfigCommon may provide a CBRA resource. The first higher layer parameter 1040 may be twoTA-Config1-r18. twoTA-Config1-r18 may provide a CFRA resource. For example, the random access procedure initiated based on one or both of twoTA-Config1-r18 and twoTA-Config2-r18 may be regarded as a random access procedure for the secondary TA acquisition.

In means 2b, the second higher layer parameter 1041 may be twoTA-Config2-r18. The third higher layer parameter 1042 may be RACH-ConfigCommon. twoTA-Config2-r18 may provide a CFRA resource. RACH-ConfigCommon may provide a CBRA resource. The random access procedure initiated based on twoTA-Config2-r18 may be regarded as the random access procedure for secondary TA acquisition. In means 2b, random access 1151 may be considered as the random access procedure for the secondary TA acquisition.

In means 2b, the third higher layer parameter 1042 may be configured. In the case that the second higher layer parameter 1041 is configured and in the case that the time alignment timer associated with the first TAG 1170 expires, the random access procedure 1150 may be initiated based on any one of the second higher layer parameter 1041 and the third higher layer parameter 1042. For example, in the case that the second higher layer parameter 1041 is not configured and in the case that the time alignment timer associated with the first TAG 1170 expires, the random access procedure 1150 may be initiated based on the second higher layer parameter 1041.

In means 2b, in the case that the second higher layer parameter 1041 is not configured and in the case that the time alignment timer associated with the first TAG 1170 expires, the random access procedure 1150 may be initiated based on the third higher layer parameter 1042.

In means 2b, in the case that the second higher layer parameter 1041 is configured and in the case that the time alignment timer associated with the second TAG 1171 expires, the random access procedure 1151 may be initiated based on the second higher layer parameter 1041.

In means 2b, in the case that the second higher layer parameter 1041 is not configured and in the case that the time alignment timer associated with the second TAG 1171 expires, the random access procedure 1151 need not be initiated.

The random access procedures 1050, 1051, and 1052 may be a CFRA or a CBRA. The random access procedure 1150 may be a CFRA or a CBRA. The random access procedure 1151 may be a CFRA. The random access procedures 1150 and 1151 may be random access procedures for the secondary TA acquisition.

Various aspects of apparatuses according to an aspect of the present embodiment will be described below.
(1) In order to accomplish the object described above, an aspect of the present invention is contrived to provide the following means. Specifically, a first aspect of the present invention is a terminal apparatus including a receiver configured to receive a PDCCH to which DCI is mapped, and a transmitter configured to transmit a random access preamble in a random access procedure initiated by the PDCCH, wherein in a case that the DCI includes a DCI field and in a case that the DCI field indicates a first value, the random access procedure is initiated based on a first higher layer parameter, in a case that the DCI includes the DCI field and in a case that the DCI field indicates a second value, the random access procedure is initiated based on a second higher layer parameter, in a case that the DCI does not include the DCI field, the random access procedure is initiated based on a third higher layer parameter, all of the first higher layer parameter, the second higher layer parameter, and the third higher layer parameter include an RACH configuration, and the first higher layer parameter corresponds to one additional PCI index. In a case that the first higher layer parameter is configured, the DCI may include the DCI field. The second higher layer parameter and the third higher layer parameter may be identical common higher layer parameters.
(2) A second aspect of the present invention is a terminal apparatus including a receiver configured to receive a PDCCH to which DCI is mapped, and a transmitter configured to transmit a random access preamble in a random access procedure initiated by the PDCCH, wherein in a case that a CORESET pool index corresponding to the PDCCH is a first value, the random access procedure is initiated based on a first higher layer parameter, in a case that a CORESET pool index corresponding to the PDCCH is a second value, the random access procedure is initiated based on a second higher layer parameter, in a case that the first higher layer parameter is not configured, the random access procedure is initiated based on a third higher layer parameter, and all of the first higher layer parameter, the second higher layer parameter, and the third higher layer parameter include an RACH configuration.
(3) A third aspect of the present invention is a terminal apparatus including a receiver configured to receive a PDCCH to which DCI is mapped, and a transmitter configured to transmit a random access preamble in a random access procedure initiated by the PDCCH, wherein in a case that a first higher layer parameter is configured and a second higher layer parameter is configured, the random access procedure is initiated based on the first higher layer parameter, in a case that the first higher layer parameter is not configured and in a case that the second higher layer parameter is configured, the random access procedure is initiated based on the second higher layer parameter, and the first higher layer parameter and the second higher layer parameter include an RACH configuration.
(4) A fourth aspect of the present invention is a terminal apparatus including a transmitter configured to transmit a random access preamble in a random access procedure, and a receiver configured to receive a random access response in the random access procedure, wherein in a case that a first higher layer parameter is configured and in a case that a first time alignment timer associated with a first TAG expires, the random access procedure is initiated based on a second higher layer parameter, in a case that the first higher layer parameter is not configured and in a case that the first time alignment timer expires, the random access procedure is initiated based on a second higher layer parameter, in a case that the first higher layer parameter is configured and in a case that a second time alignment timer associated with a second TAG expires, the random access procedure is initiated based on the first higher layer parameter, in a case that the first higher layer parameter is not configured and in a case that the second time alignment timer expires, the random access procedure is not initiated, and the first higher layer parameter and the second higher layer parameter include an RACH configuration. The random access procedure initiated based on the first higher layer parameter may be regarded as a random access procedure for a secondary TA acquisition. The first TAG may correspond to one additional PCI.
(5) A fifth aspect of the present invention is a terminal apparatus including a transmitter configured to transmit a random access preamble in a random access procedure, and a receiver configured to receive a random access response in the random access procedure, wherein in a case that a third higher layer parameter is configured and a second higher layer parameter is configured, and in a case that a first time alignment timer associated with a first TAG expires, the random access procedure is initiated based on any one of the second higher layer parameter and the third higher layer parameter, in a case that the second higher layer parameter is not configured and in a case that the first time alignment timer expires, the random access procedure is initiated based on the third higher layer parameter, in a case that the second higher layer parameter is configured and in a case that a second time alignment timer associated with a second TAG expires, the random access procedure is initiated based on the second higher layer parameter, in a case that the second higher layer parameter is not configured and in a case that the second time alignment timer expires, the random access procedure is not initiated, the second higher layer parameter and the third higher layer parameter include an RACH configuration, and the first TAG and the second TAG correspond to one serving cell. The random access procedure in the case that the second time alignment timer expires may be regarded as a random access procedure for a secondary TA acquisition.
(6) A sixth aspect of the present invention is a base station apparatus including a receiver configured to receive a random access preamble in a random access procedure, and a transmitter configured to transmit a random access response in the random access procedure, wherein in a case that a first higher layer parameter is configured and in a case that a first time alignment timer associated with a first TAG expires, the random access procedure is initiated based on a second higher layer parameter, in a case that the first higher layer parameter is not configured and in a case that the first time alignment timer expires, the random access procedure is initiated based on a second higher layer parameter, in a case that the first higher layer parameter is configured and in a case that a second time alignment timer associated with a second TAG expires, the random access procedure is initiated based on the first higher layer parameter, in a case that the first higher layer parameter is not configured and in a case that the second time alignment timer expires, the random access procedure is not initiated, and the first higher layer parameter and the second higher layer parameter include an RACH configuration. The random access procedure initiated based on the first higher layer parameter may be regarded as a random access procedure for a secondary TA acquisition. The first TAG may correspond to one additional PCI.

Each program running on the base station apparatus 3 and the terminal apparatus 1 according to an aspect of the present invention may be a program that controls a central processing unit (CPU) and the like (a program causing a computer to function) to realize the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. In addition, the “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although the embodiments of the present invention have been described in detail above referring to the drawings, the specific configuration is not limited to the embodiments and includes, for example, design changes within the scope that do not depart from the gist of the present invention. For an aspect of the present invention, various modifications are possible within the scope of the claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
10, 30 Radio transmission and/or reception unit
10a, 30a Radio transmission unit
10b, 30b Radio reception unit
11, 31 Antenna unit
12, 32 RF unit
13, 33 Baseband unit
14, 34 Higher layer processing unit
15, 35 Medium access control layer processing unit
16, 36 Radio resource control layer processing unit
91, 92, 93, 94 Search space set
300 Component carrier
301 Primary cell
302, 303 Secondary cell
700 Set of resource elements for PSS
710, 711, 712, 713 Set of resource elements for PBCH and DMRS for PBCH
720 Set of resource elements for SSS
3000 Point
3001, 3002 Resource grid
3003, 3004 BWP
3011, 3012, 3013, 3014 Offset
3100, 3200 Common resource block set
9000, 9001 Random access (random access procedure)
9010, 9011 Random access preamble
9020, 9021 Random access response
9030, 9031 TRP information
9040, 9041 TRP
9050, 9051 TA command
9060, 9061 TA
9070, 9071 Uplink timing
9080, 9081 Uplink frame
9082 Downlink frame
9090 Prescribed time
9100, 9101 Uplink physical channel
9200, 9201 subTAG
9300, 9301 TAG ID
9400, 9401 TA offset
9500, 9501, 9502 TAG
9800, 9801, 9802 Time alignment timer
9900 Serving cell
1000 DCI
1010 PDCCH
1015, 1115 Random access preamble
1020 DCI field
1025, 1125 PRACH occasion
1030, 1031 Value
1040, 1041, 1042 Higher layer parameter
1050, 1051, 1052, 1150, 1151 Random access procedure
1160 Random access response
1170, 1171 TAG

1. A terminal apparatus comprising:
a receiver configured to receive a PDCCH to which DCI is mapped; and
a transmitter configured to transmit a random access preamble in a random access procedure initiated by the PDCCH, wherein
in a case that the DCI includes a DCI field and in a case that the DCI field indicates a first value, the random access procedure is initiated based on a first higher layer parameter,
in a case that the DCI includes the DCI field and in a case that the DCI field indicates a second value, the random access procedure is initiated based on a second higher layer parameter,
in a case that the DCI does not include the DCI field, the random access procedure is initiated based on a third higher layer parameter,
all of the first higher layer parameter, the second higher layer parameter, and the third higher layer parameter include an RACH configuration, and
the first higher layer parameter corresponds to one additional PCI index.

2. The terminal apparatus according to claim 1, wherein in a case that the first higher layer parameter is configured, the DCI includes the DCI field.

3. The terminal apparatus according to claim 1, wherein the second higher layer parameter and the third higher layer parameter are identical common higher layer parameters.

4. (canceled)

5. (canceled)

6. A base station apparatus comprising:
a transmitter configured to transmit a PDCCH to which DCI is mapped; and
a receiver configured to receive a random access preamble in a random access procedure initiated by the PDCCH, wherein
in a case that the DCI includes a DCI field and in a case that the DCI field indicates a first value, the random access procedure is initiated based on a first higher layer parameter,
in a case that the DCI includes the DCI field and in a case that the DCI field indicates a second value, the random access procedure is initiated based on a second higher layer parameter,
in a case that the DCI does not include the DCI field, the random access procedure is initiated based on a third higher layer parameter,
all of the first higher layer parameter, the second higher layer parameter, and the third higher layer parameter include an RACH configuration, and
the first higher layer parameter corresponds to one additional PCI index.

7. The base station apparatus according to claim 6, wherein in a case that the first higher layer parameter is configured, the DCI includes the DCI field.

8. The base station apparatus according to claim 6, wherein the second higher layer parameter and the third higher layer parameter are identical common higher layer parameters.

9. A communication method used in a terminal apparatus, the communication method comprising:
receiving a PDCCH to which DCI is mapped; and
transmitting a random access preamble in a random access procedure initiated by the PDCCH, wherein
in a case that the DCI includes a DCI field and in a case that the DCI field indicates a first value, the random access procedure is initiated based on a first higher layer parameter,
in a case that the DCI includes the DCI field and in a case that the DCI field indicates a second value, the random access procedure is initiated based on a second higher layer parameter,
in a case that the DCI does not include the DCI field, the random access procedure is initiated based on a third higher layer parameter,
all of the first higher layer parameter, the second higher layer parameter, and the third higher layer parameter include an RACH configuration, and
the first higher layer parameter corresponds to one additional PCI index.
